(19) United States
(12) Patent Application Publication
(10) Pub. No.: US 2022/0349251 A1
(43) Pub. Date: Nov. 3, 2022

(54) VERTICAL BLIND

(71) Applicant: Nien Made Enterprise Co., Ltd., Taichung City (TW)

(72) Inventors: Xu Wu QU, Taichung City (TW); Lin CHEN, Taichung City (TW); Cheng Chi LIANG, Taichung City (TW)

(73) Assignee: Nien Made Enterprise Co., Ltd., Taichung City (TW)

(21) Appl. No.: 17/569,025

(22) Filed: Jan. 5, 2022

(30) Foreign Application Priority Data
Apr. 28, 2021 (CN) 202110499374.2

(51) Int. Cl. E06B 9/36

(52) U.S. Cl. CPC E06B 9/368; E06B 9/361

(57) ABSTRACT

A vertical blind has a headrail, a transmission shaft, a plurality of slats located below the headrail with a gap, a driving assembly, a first clutch, a first pushing component, and a light-blocking member configured to be driven by the first pushing component to move from a blocking position coving the gap to a non-blocking position revealing at least a part of the gap. When the transmission shaft is driven to rotate in a first direction, the first pushing component is moved toward the first end of a movable region. When the first pushing component has been moved to the first end of the movable region and the transmission shaft keeps being driven to rotate in the first direction, the first clutch prevents the transmission shaft from further driving the first pushing component, whereby the first pushing component stays at substantially the first end of the movable region.

### BACKGROUND OF THE DISCLOSURE

### Field of the Disclosure

The present disclosure relates generally to a vertical blind, and more particularly relates to the vertical blind with an enhanced light-blocking capability.

### Description of the Prior Art

A conventional vertical blind usually comprises a headrail, a slat assembly, and a driving assembly. The slat assembly is operably suspended below the headrail and comprises a plurality of slats. The user can stack and separate the slats of the slat assembly by using a cord or a wand of the driving assembly. The driving assembly can be also used to turn the slats for adjusting the amount of light passing through the slats. In order to prevent the slats from interfering with the headrail while the slats are turned or moved, a gap is deliberately kept between the top of the slats and the bottom of the headrail in conventional vertical blinds.

When the user wants to block out all the light from outside by turning the slats to a fully closed position, the light still passes through the deliberately kept gap. In other words, this kind of vertical blinds cannot provide a satisfactory light-blocking effect.

To deal with this problem, some vertical blinds are provided with a light-blocking plate, either in fixedly, or non-fixedly. A light-blocking plate may be fixed to the front side or the rear side of a headrail in a non-adjustable manner to cover the gap between the bottom of the headrail and the top of the slats. When the slats are moved or turned, the non-adjustable light-blocking plate may not hinder the movement of the slats. The non-adjustable light-blocking plate may also need to cover the gap between the bottom of the headrail and the top of the slats completely when the slats are turned to a fully closed position. Therefore, the non-adjustable light-blocking plate usually takes up a lot of space, which is usually not aesthetically appealing and not easy to install.

The adjustable light-blocking plate may be pivotably connected to the headrail and pushed by the slats. When the slats are turned to a fully light-blocking position, the adjustable light-blocking plate pivots downwards to cover the gap between the headrail and the slats. When the slats are turned to an open position, the adjustable light-blocking plate is pushed by the top of the slats and pivot upwards.

Because the adjustable light-blocking plates need to be pushed by the slats, the slats of the vertical blinds must have enough stiffness. Furthermore, the interference between the adjustable light-blocking plates and the slats may hinder the turning and the moving of the slat, which leads to unpleasant noises and even the damage of the slats.

In addition, when the slats are stacked together, the adjustable light-blocking plate may not be evenly supported and tilt. A tilting light-blocking plate may ruin the aesthetics and even lead to the malfunction.

### SUMMARY OF THE DISCLOSURE

In light of the above reasons, one aspect of the present disclosure is to provide a vertical blind that could effectively enhance an overall light-blocking effect. The slats would not interfere with the light-blocking member while the slats are being turned or moved. The slats could be manipulated smoothly, and the noise when operating the slats could be effectively reduced.

To achieve the above objective, the present disclosure provides an embodiment of a vertical blind, which comprises a headrail, a transmission shaft, a plurality of slats, a driving assembly, a first clutch, a first pushing component, and a light-blocking member. The transmission shaft is located in the headrail. The plurality of slats are connected to the transmission shaft and located below the headrail with a gap formed between the slats and the headrail, wherein the slats are movable along the transmission shaft and driven to turn by the transmission shaft. The driving assembly is connected to the transmission shaft for driving the transmission shaft to turn the slats between a first closed position and a second closed position, wherein an open position is defined between the first and second closed positions. The first clutch is connected to the transmission shaft. The first pushing component is connected to the transmission shaft through the first clutch to be driven to move between a first end and a second end of a movable region. The light-blocking member is configured to be driven by the first pushing component to move from a blocking position coving the gap to a non-blocking position revealing at least a part of the gap. When the slats are at the first closed position, the light-blocking member is located at the blocking position. When the slats are turned from the first closed position to the open position, the transmission shaft drives the first pushing component to push the light-blocking member to move towards the non-blocking position. When the transmission shaft is driven to rotate in a first direction, the first pushing component is moved toward the first end of the movable region. When the transmission shaft is driven to rotate in a second direction opposite to the first direction, the first pushing component is moved toward the second end of the movable region. When the first pushing component has been moved to the first end of the movable region and the transmission shaft keeps being driven to rotate in the first direction, the first clutch prevents the transmission shaft from further driving the first pushing component, whereby the first pushing component stays at substantially the first end of the movable region.

In another embodiment, when the first pushing component has been moved to the first end of the movable region, the transmission shaft keeps being driven to rotate in the first direction, and a torque applied to the first clutch from the transmission shaft is higher than a predetermined torque value, the first clutch is disengaged from the transmission shaft.

In another embodiment, the transmission shaft comprises a shaft body and a plurality of splines. The splines are equally spaced and provided on a circumference of the shaft body along an axial direction of the shaft body of the transmission shaft. The first clutch comprises a clutch base and an extending arm. The extending arm comprises a fixed end connected to the clutch base and a free end away from the fixed end so that the extending arm is pivotable relative to the clutch base. The shaft body passes through the clutch base. The extending arm has a toothed portion for engaging with the splines.

In another embodiment, when the first pushing component has been moved to the first end of the movable region and the transmission shaft keeps being driven to rotate in the first direction, the splines push the free end of the extending arm pivoting upwards, whereby the toothed portion of the extending arm of the first clutch is disengaged from the splines of the transmission shaft to prevent the transmission shaft from further driving the first pushing component.

In another embodiment, the headrail comprises a restricting chamber. The restricting chamber comprises a non-restricting portion and a restricting portion. At least a part of the extending arm of the first clutch is accommodated in the restricting chamber. When the first pushing component is driven to move between the first end and the second end of the movable region, the extending arm of the first clutch is located in and restricted by the restricting portion from pivoting, whereby the toothed portion of the extending arm of the first clutch remains engaged with the splines of the transmission shaft. When the first pushing component has been moved to the first end of the movable region and the transmission shaft keeps being driven to rotate in the first direction, the extending arm is moved to and pivots in the non-restricting portion, whereby the toothed portion of the extending arm of the first clutch is intermittently disengaged from the splines of the transmission shaft to prevent the transmission shaft from further driving the first pushing component.

In another embodiment, the headrail comprises an accommodating space and a base provided in the accommodating space. The restricting chamber is provided on the base for accommodating the extending arm of the first clutch.

In another embodiment, the headrail comprises a frame, an end cap, and an accommodating space. The end cap is provided at an end of the frame to define a boundary of the accommodating space. The restricting chamber is provided on an inner surface of the end cap for accommodating the extending arm of the first clutch.

In another embodiment, an imaginary line passing through the fixed end and the free end of the extending arm is substantially perpendicular to the axial direction of the shaft body of the transmission shaft.

In another embodiment, an imaginary line passing through the fixed end and the free end of the extending arm is substantially parallel to the axial direction of the shaft body of the transmission shaft.

In another embodiment, the transmission shaft comprises a sleeve and a shaft body. The sleeve fits around the shaft body and is non-rotatable relative to the shaft body. When a first torque applied to the first clutch by the shaft body of through the sleeve is less than a predetermined torque value, the first clutch is engaged with and rotates along with the sleeve of the transmission shaft. When a second torque applied to the first clutch by the shaft body of through the sleeve is greater than the predetermined torque value, the first clutch slips relative to the sleeve of the transmission shaft.

In another embodiment, when the second torque applied to the first clutch by the shaft body through the sleeve is greater than the predetermined torque value, at least one of the sleeve and the first clutch deforms temporarily.

In another embodiment, the sleeve comprises an outer ridge structure. The first clutch further comprises an inner toothed structure for engaging with the outer ridge structure of the sleeve so as to be driven by the transmission shaft. When the second torque applied to the first clutch by the transmission shaft through the sleeve is greater than the predetermined torque value, at least one of the sleeve and the first clutch deforms temporarily so that the inner toothed structure of the first clutch and the outer ridge structure of the sleeve are disengaged.

In another embodiment, the vertical blind further comprises a positioning mechanism concurrently movable along with the first pushing component. The headrail comprises a stop portion. The positioning mechanism and the stop portion collectively restrict the first pushing component from moving out of the movable region.

In another embodiment, when the first pushing component has been moved to the second end of the movable region and the transmission shaft keeps being driven to rotate in the second direction, the first clutch prevents the transmission shaft from further driving the first pushing component, whereby the first pushing component stays at substantially the second end of the movable region.

In another embodiment, the vertical blind further comprises an intermediate device connected to the light-blocking member and provided between the first pushing component and the light-blocking member. When the transmission shaft drives the slats to turn from the first closed position toward the open position, the transmission shaft drives the first pushing component to push the intermediate device for moving the light-blocking member toward the non-blocking position.

In another embodiment, the intermediate device comprises a moving block. The first pushing component is engaged with the moving block. When the transmission shaft drives the slats to turn from the first closed position toward the open position, the transmission shaft drives the first pushing component to push the moving block for moving the light-blocking member toward the non-blocking position.

In another embodiment, the intermediate device comprises a driving ring and a swing arm. The first pushing component is engaged with the driving ring. The swing arm is connected to the driving ring and pivotable relative to the driving ring. When the transmission shaft drives the slats to turn from the first closed position toward the open position, the transmission shaft drives the first pushing component to push the driving ring for pivoting the swing arm, whereby to move the light-blocking member toward the non-blocking position.

In another embodiment, when the transmission shaft drives the slats to turn from the open position toward the first closed position, the light-blocking member is driven by gravity to move from the non-blocking position toward the blocking position and pushes the intermediate device downward.

In another embodiment, the light-blocking member is supported by the first pushing component and separated from the slats so that the light-blocking member does not contact the slats while the light-blocking member is being moved between the blocking position and the non-blocking position.

In another embodiment, the vertical blind further comprises a second clutch and a second pushing component, wherein the second pushing component is engaged with the second clutch. The first pushing component and the second pushing component are respectively moved in different directions with respect to the transmission shaft.

Through the collaboration of the driving assembly, the transmission shaft, the slats, the pushing component, and the light-blocking member, when the slats are turned to the open position, the light-blocking member would be driven by the pushing component to move to the non-blocking position. Conversely, when the slats are turned to the closed positions, the light-blocking member would be moved to the blocking position to effectively cover the gap. Therefore, the vertical blind of the present disclosure could provide a better light-blocking effect. Furthermore, the slats would not interfere with the light-blocking mechanism while the slats are turned or moved. The light-blocking member would also not tilt even if the slats are stacked.

The vertical blind of the present disclosure will be illustrated in detail in the following descriptions. However, it should be understood by people having ordinary skills in the art that the detailed illustrations and the embodiments are merely for the purpose of explaining the concept of the present disclosure, and are not limitations to the scope of claims.

### BRIEF DESCRIPTION OF THE DRAWINGS

The present disclosure will be understood by referring to the following detailed description of some illustrative embodiments in conjunction with the accompanying drawings, in which:

FIG. 1 is a perspective view of a first embodiment of a vertical blind of the present disclosure, wherein the slats are at the first closed position;

FIG. 2 is a right side view of the vertical blind in FIG. 1;

FIG. 3 is a sectional view of the vertical blind in FIG. 1 along the line A-A′;

FIG. 4 is another perspective view of the first embodiment of the vertical blind, wherein the slats are at the open position;

FIG. 5 is an exploded view showing a part of the vertical blind in FIG. 4;

FIG. 6 is an enlarged view showing a part of the vertical blind in FIG. 5;

FIG. 7 is also another enlarged view showing a part of the vertical blind in FIG. 5, viewed from another angle;

FIG. 8 is a left side view of the first pushing component of the vertical blind in FIG. 6;

FIG. 9 is a right side view of the first pushing component of the vertical blind in FIG. 6;

FIG. 10 is a bottom view of the first pushing component of the vertical blind in FIG. 6;

FIG. 11 is a left side view of the first end cap of the vertical blind in FIG. 6;

FIG. 12 is a right side view of the first base of the vertical blind in FIG. 6;

FIG. 13 is a right side view of the vertical blind in FIG. 4;

FIG. 14 is another sectional view of the vertical blind in FIG. 4 along the line B-B′;

FIG. 15 is another perspective view of the first embodiment of the vertical blind , wherein the slats are at the second closed position;

FIG. 16 is another right side view of the vertical blind in FIG. 15;

FIG. 17 is another sectional view of the vertical blind in FIG. 15 along the line C-C′;

FIG. 18 is a perspective view of a second embodiment of a vertical blind of the present disclosure, wherein the slats are at the first closed position;

FIG. 19 is a right side view of the vertical blind in FIG. 18;

FIG. 19A is a sectional view of the vertical blind in FIG. 18 along the line D-D′;

FIG. 20 is another perspective view of the second embodiment of the vertical blind, wherein the slats are at the open position;

FIG. 21 is a right side view of the vertical blind in FIG. 20;

FIG. 21A is another sectional view of the vertical blind in FIG. 20 along the line E-E′;

FIG. 22 is an exploded view showing a part of the vertical blind in FIG. 20;

FIG. 23 is another exploded view showing a part of the vertical blind in FIG. 20, viewed from another angle;

FIG. 24 is a perspective view of the first pushing component of the vertical blind in FIG. 22;

FIG. 25 is a right side view of the first pushing component of the vertical blind in FIG. 22;

FIG. 26 is a top view of the first pushing component of the vertical blind in FIG. 22;

FIG. 27 is a left side view of the first end cap of the vertical blind in FIG. 22;

FIG. 28 is an exploded view showing a part of a third embodiment of a vertical blind of the present disclosure;

FIG. 29 is another exploded view showing the part of the vertical blind in FIG. 28, viewed from another angle;

FIG. 30 is a perspective view of the first pushing component of the vertical blind in FIG. 28;

FIG. 31 is a rear view of the first pushing component of the vertical blind in FIG. 28;

FIG. 32 is another perspective view of the first pushing component of the vertical blind in FIG. 28, viewed from another angle;

FIG. 33 is a left side view of the first end cap of the vertical blind in FIG. 28;

FIG. 34 is an exploded view showing a part of a fourth embodiment of a vertical blind of the present disclosure;

FIG. 35 is another exploded view showing a part of the vertical blind in FIG. 34, viewed from another angle;

FIG. 36 is a perspective view showing the sleeve and the first clutch of the vertical blind in FIG. 34;

FIG. 37 is another perspective view showing the sleeve and the first clutch of the vertical blind in FIG. 34, viewed from another angle;

FIG. 38 is an exploded view showing a part of a fifth embodiment of a vertical blind of the present disclosure;

FIG. 39 is another exploded view showing the part of the vertical blind in FIG.38, viewed from another angle;

FIG. 40 is a perspective view showing the sleeve and the first clutch of the vertical blind in FIG. 38; and

FIG. 41 is another perspective view showing the sleeve and the first clutch of the vertical blind in FIG. 38, viewed from another angle.

### DETAILED DESCRIPTION

In the following paragraphs and the accompanying drawings, the features and the implementations of vertical blinds of the present disclosure are described in more detail. One or more embodiments of the vertical blinds of the present disclosure are shown and illustrated in the accompanying drawings. The features and the implementations described in the following paragraphs can be adopted solely or in combination with each other. In addition, the vertical blinds can be embodied in various forms, as disclosed in the following paragraphs, and should not be limited to the embodiments described in the following paragraphs. Unless specified otherwise, the same reference characters refer to the same components.

The technical features provided in the present disclosure are not limited to the specific structures, uses, and applications described in the embodiments. The language used in the descriptions is illustrative and descriptive language which can be understood by the person of ordinary skill in the art. The terms regarding directions mentioned in the specification, including “front”, “rear”, “up”, “down”, “left”, “right”, “top”, “bottom”, “inside”, and “outside”, are illustrative and descriptive terms based on common usage scenarios, and manifests no intent to limit the scope of claims.

Furthermore, the definite and indefinite articles “a” and “the” and the numerical term “one” used in the specification referring to components of singular form do not exclude the concept of plural form. Equivalences known by one having ordinary skill in the art should be also included. All conjunctions used in similar situations should be interpreted in the broadest ways. The specific shapes, structural features, and technical terms described in the descriptions should also be interpreted to include equivalent structures and techniques which could achieve the same functionality.

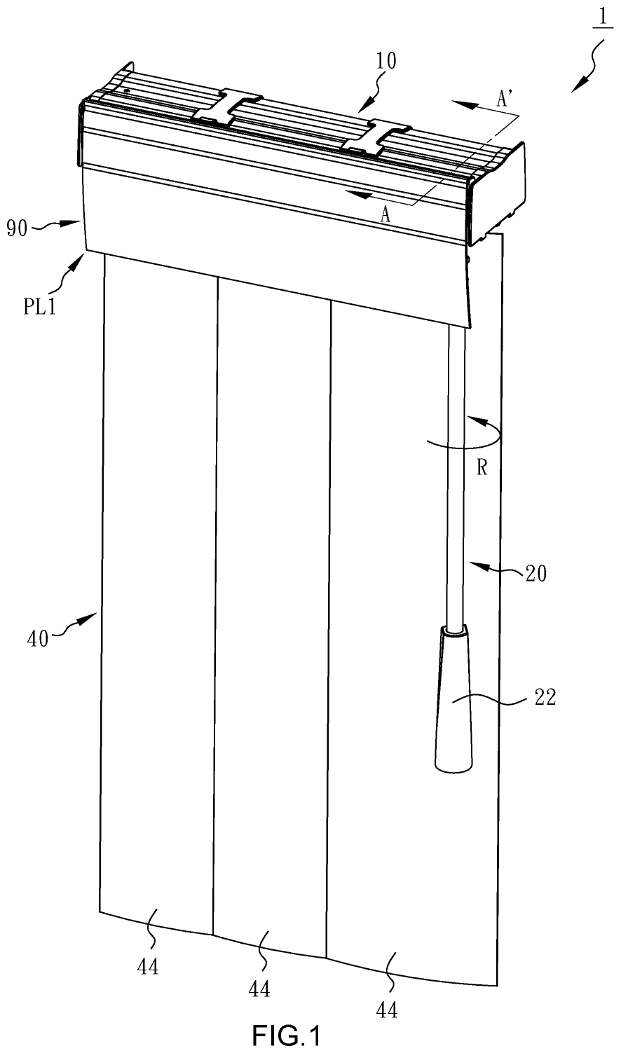

A first embodiment of a vertical blind 1 of the present disclosure is shown in FIGS. 1-17, which can be installed at building openings such as windows, doors, and archways. The vertical blind 1 comprises a headrail 10, a driving assembly 20, a transmission shaft 30, a slat assembly 40, a first pushing component 51, a first clutch 61, a first positioning mechanism 71, a first intermediate device 81, and a light-blocking member 90. The vertical blind 1 could be operated to adjust the amount of light passing through.

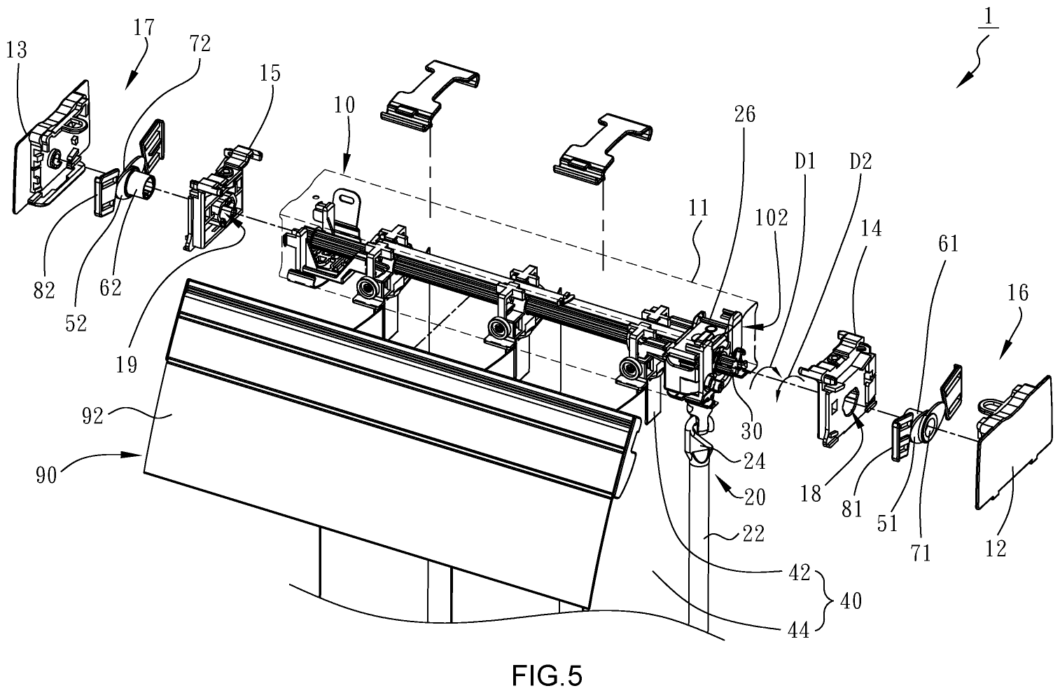

The components and operations of the vertical blind 1 are explained with FIGS. 5-7.

The headrail 10 may be configured to accommodate the transmission shaft 30 and other components. The headrail 10 comprises a frame 11, a first end cap 12, and a first base 14. The frame 11 of the headrail 10 can be utilized to install at a building opening. The frame 11 may be realized with a channel bar or other suitable structures, and comprises an accommodating space 102. The first end cap 12 may be engaged with a first end of the frame 11 to define a boundary of the accommodating space 102. The first base 14 is received in the accommodating space 102 of the frame 11.

The driving assembly 20 is utilized to control movements of the slat assembly 40 and the light-blocking member 90 of the vertical blind 1. The driving assembly 20 comprises a wand 22 and a connecting member 24. A top end of the wand 22 is connected to the transmission shaft 30 through the connecting member 24.

The transmission shaft 30 may be driven by the driving assembly 20 to move the slat assembly 40 and the light-blocking member 90. The transmission shaft 30 comprises a shaft body 32 and a plurality of splines 34. The splines 34 are equally spaced and provided on a circumference of the shaft body 32 in an axial direction of the shaft body 32. For example, the splines may also be spirally formed on the circumference of the shaft body 32 in the axial direction of the shaft body 32. The splines 34 may also be parallel to the axial of the shaft body 32 or realized with other suitable structures.

The slat assembly 40 may be operated to cover or reveal the building opening. The slat assembly 40 comprises a plurality of clips 42 and a plurality of slats 44. The clips 42 are utilized to couple the transmission shaft 30 and the slats 44. For example, the slats 44 may be suspended below the transmission shaft 30 through the clips 42.

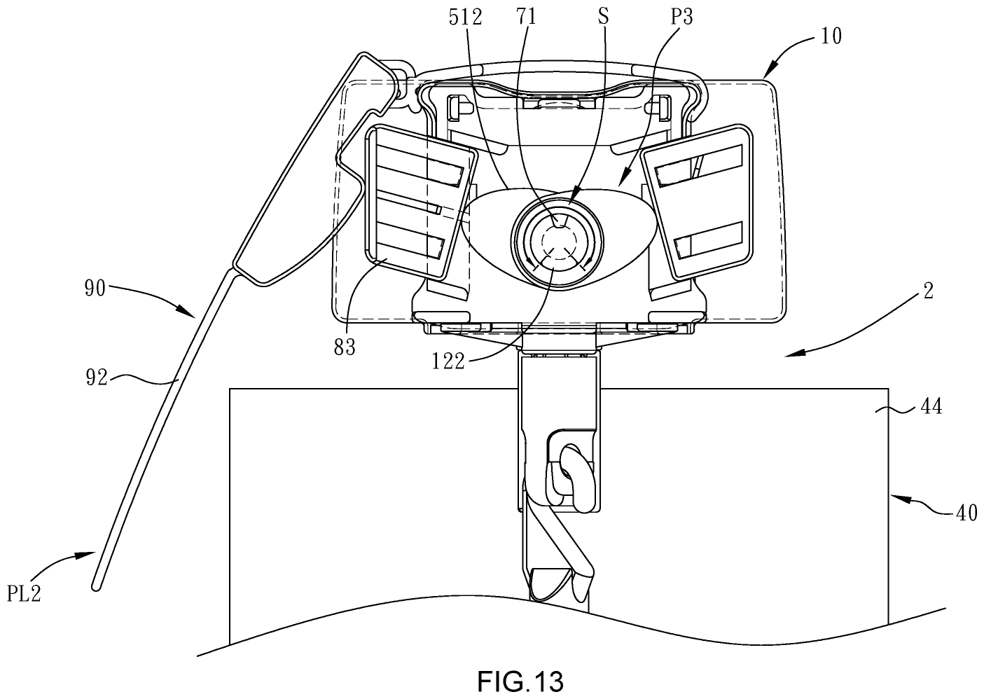

The first pushing component 51 is connected to and driven by the transmission shaft 30 to move in a movable region S (e.g., the curved region S shown in FIG. 13) whereby to move the light-blocking member 90.

The first clutch 61 is located between the transmission shaft 30 and the first pushing component 51 to engage or disengage the transmission shaft 30 and the first pushing component 51. In this embodiment, the first clutch 61 comprises a clutch base 64 and a curved extending arm 66. The clutch base 64 and the extending arm 66 collectively form a hollow cylinder for fitting around the transmission shaft 30.

The first positioning mechanism 71 is provided at the first pushing component 51 to define the movable region S of the first pushing component 51.

The first intermediate device 81 is provided between the first pushing component 51 and the light-blocking member 90. The first pushing component 51 drives the light-blocking member 90 to move through the first intermediate device 81.

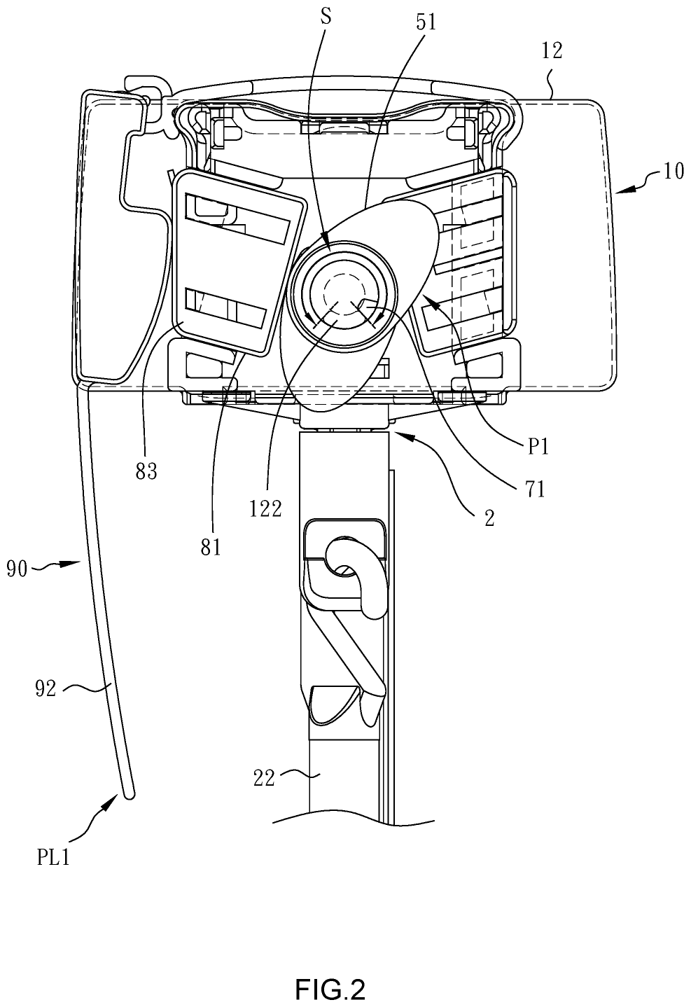

The light-blocking member 90 comprises a front cover plate 92, which is configured to move between a blocking position PL1 and a non-blocking position PL2. When the front cover plate 92 is at the blocking position PL1, a gap 2 between the slats 44 and the headrail 10 would be covered, as shown in FIGS. 1 and 2.

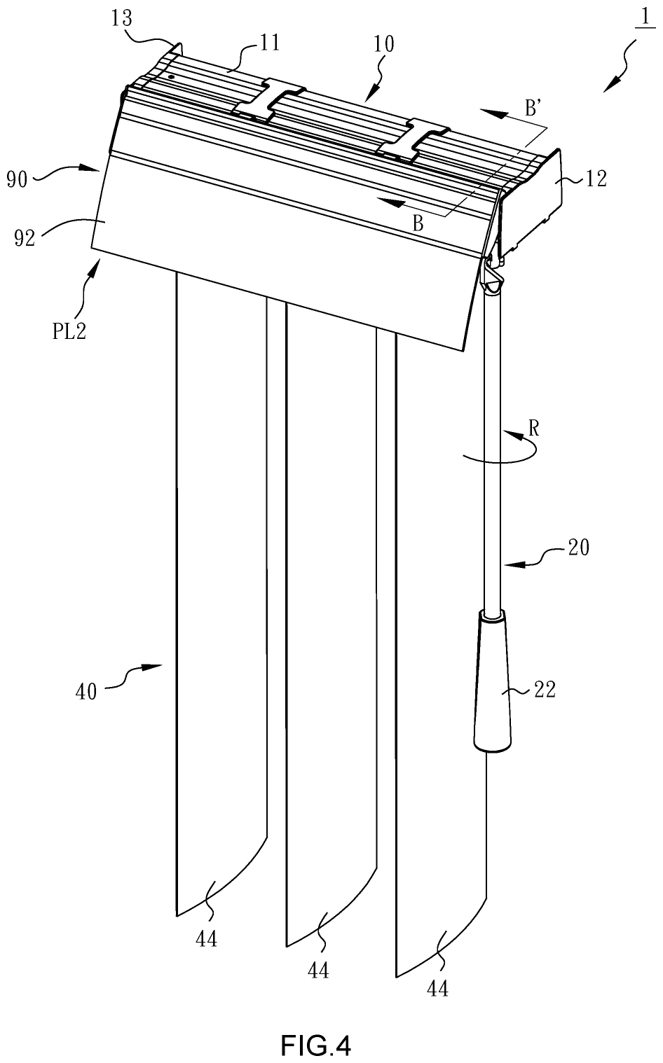

The structures and operations of the components in the headrail 10 are illustrated in FIGS. 4-10 and elaborated below.

The headrail 10 can be realized with plastic, metal, alloy, composite materials and/or other suitable materials. The headrail 10 is rigid enough for carrying other components received therein. In the present embodiment, the headrail 10 is realized with a substantially hollow rectangular cuboid, e.g., a channel bar with a movable lid coving the opening. The first base 14 of the headrail 10 is located in the accommodating space 102 of the frame 11 so that a first operation space 16 exists between the first end cap 12 and the first base 14. The first base 14 of the headrail 10 further comprises a first restricting chamber 18 to accommodate at least part of the first clutch 61. The first restricting chamber 18 and the first clutch 61 will be described in more detail below.

A turning assembly 26 of the driving assembly 20 is located in the accommodating space of the headrail 10. The turning assembly 26 may comprise a bevel gear and/or other suitable components for coupling with and driving the transmission shaft 30. The wand 22 is coupled with the turning assembly 26 through the connecting member 24 for driving the transmission shaft 30 to rotate. A bottom end of the wand 22 is exposed out of the headrail 10 to be operated by the user. In this embodiment, the transmission shaft 30 is driven to rotate by rotating the wand 22. In other embodiments, the transmission shaft 30 could also be driven by a cord, a motor, a spring, suitable manual operated components and/or suitable electrically driven components (not shown) of the driving assembly 20.

The transmission shaft 30 is located in the accommodating space 102 of the headrail 10, and the axial of the shaft body 32 of the transmission shaft 30 is arranged substantially in the longitudinal direction the headrail 10. In the present embodiment, the number of the splines 34 of the transmission shaft 30 is eight. However, the number of the splines 34 is configured to be four, five, six, or other suitable numbers.

The slat assembly 40 is located below the headrail 10. The clips 42 of the slat assembly 40 are configured to be rotated by the transmission shaft 30, and the clips are arranged substantially along the longitudinal direction of the headrail 10. In the present embodiment, the number of the slats 44 and the number of the clips 42 are the same. In another embodiment, the number of the clips 42 and the number of the slats 44 may be configured to be different. A width of the gap 2 between the slats 44 and the headrail 10 is configured to be substantially the same. When the slats 44 are manipulated to move or turn relative to the headrail 10, the slats 44 are configured to not interfere with the headrail 10.

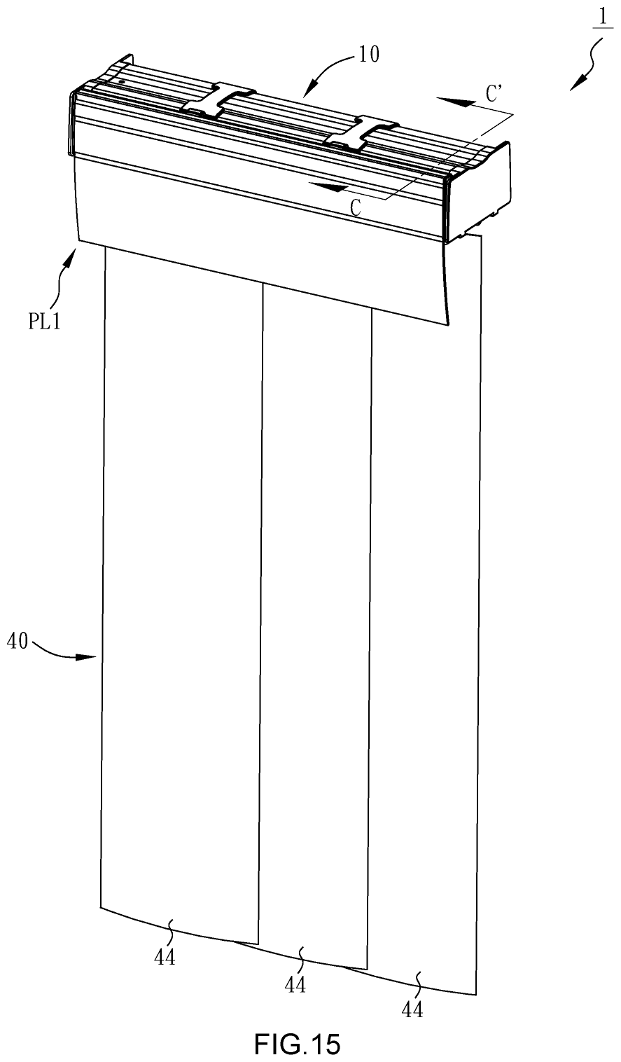

The operations of the driving assembly 20, the transmission shaft 30, and the slat assembly 40 will be described in more detail below. When the wand 22 of the driving assembly 20 is rotated by the user, the transmission shaft 30 would be driven to rotate. The rotation of the transmission shaft 30 would drive the clips 42 and the slats 44 of the slat assembly 40 to turn. By manipulating the wand 22, the slats 44 could be turned to the condition shown in FIG. 1, wherein the adjacent slats 44 partially overlap each other to block light from passing through. The position of the slats 44 in FIG. 1 is referred as a first closed position hereinafter. The slats 44 can be manipulated to turn in a predetermined rotating direction R from the first closed position shown in FIG. 1 to the position shown in FIG. 4, at which the surfaces of the slats 44 are arranged substantially in parallel so as to let in the most amount of light. The position of the slats 44 in FIG. 4 is referred as an open position hereinafter. After the slats 44 are turned from the first closed position shown in FIG. 1 to the open position shown in FIG. 4, if the wand 22 keeps being rotating in the same direction, the position of the slats 44 can be turned to another closed position shown in FIG. 15, which is referred as a second closed position hereinafter. In the second closed position, the adjacent slats 44 partially overlap each other to block light from passing through. The slats 44 may be separated below the headrail 10 as shown in FIG. 4, and some or all of the slats 44 can also be moved to stack at one or more suitable locations (not shown).

As shown in FIGS. 5-10, the first pushing component 51 is connected to the transmission shaft 30 and accommodated in the first operation space 16 defined by the first base 14 and the first end cap 12. The first pushing component 51 is configured to be driven by the transmission shaft 30 to move within the movable region S, e.g., the transmission shaft 30 may drive the first pushing component 51 to rotate in the curved region S shown in FIG. 13. In the present embodiment, the first pushing component 51 can be realized with plastic, metal, alloy, composite materials, and/or other suitable materials with required hardness. The first pushing component 51 comprises one or more plate cams. In one embodiment, the first pushing component 41 comprises only one plate cam 512. A base circle of the plate cam 512 fits around the transmission shaft 30 so that a working curve of the plate cam 512 is configured to move the light-blocking member 90 between a blocking position PL1 and a non-blocking position PL2. When the transmission shaft 30 drives the first pushing component 51 to rotate, the plate cam 512 could directly or indirectly move the light-blocking member 90. The number and the shape of the plate cam of the first pushing component 51 may be adjusted according to different design considerations. The plate cam(s) may also be integrally formed on or attached to the first pushing component 51. In the present embodiment as shown in FIGS. 5-10, the first pushing component 51 comprises two plate cams 512 and 513. Both the plate cams 512 and 513 fit around the transmission shaft 30 and extend in different radial directions of the transmission shaft 30. The working curves of the two plate cams 512 and 513 are not overlapped at the same time. In another embodiment, the vertical blind comprises two light-blocking members respectively on both sides of the headrail 10. When the transmission shaft 30 drives the first pushing component 51 to rotate, the plate cams 512 and 513 may be respectively configured to directly or indirectly move one of the light-blocking members. In another embodiment, the vertical blind comprises one light-blocking member and a first pushing component with two plate cams. The light blocking member may be installed at either side of the headrail and still may be moved by one of the plate cams of the first pushing component.

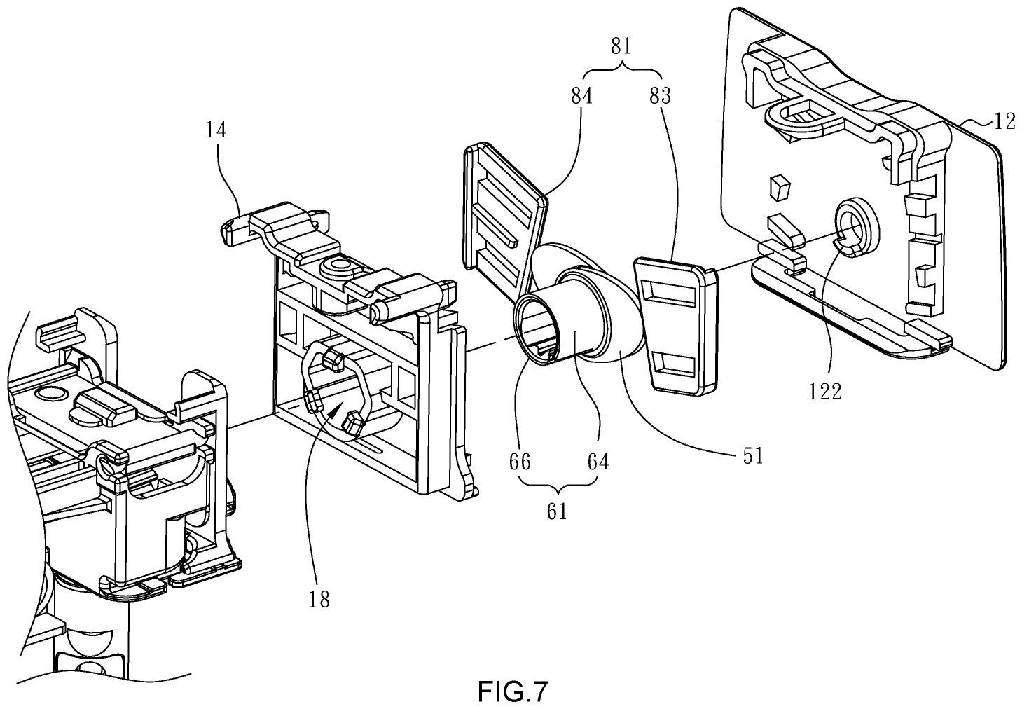

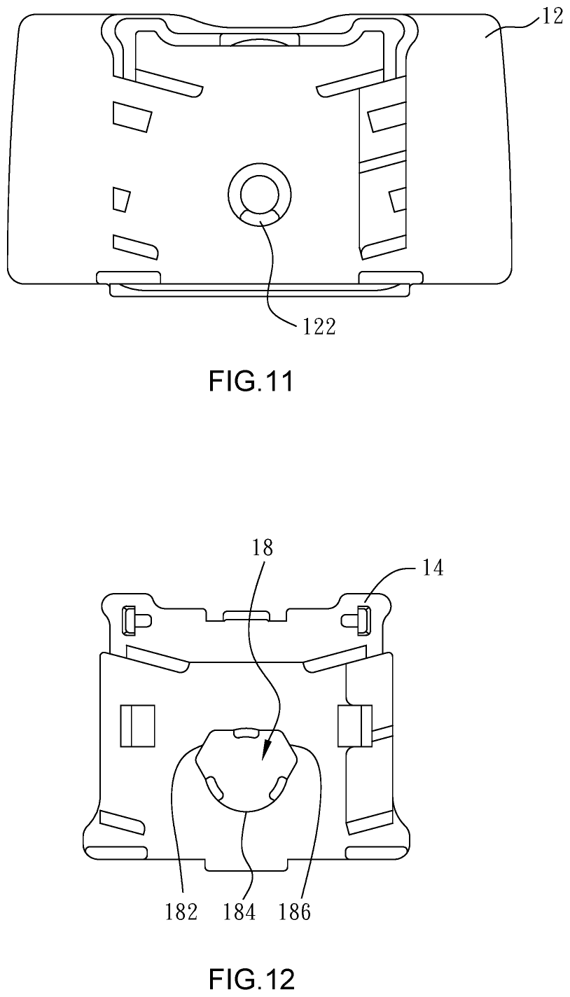

In the present embodiment, the first pushing component 51 comprises a first side away from the first end cap 12 and a second side close to the first end cap 12. The first side of the first pushing component 51 is connected to the transmission shaft 30 through the first clutch 61, whereby the first pushing component 51 may be engaged with or disengaged from the transmission shaft 30 according to the status of the first clutch 61. The second side of the first pushing component 51 is connected to the first positioning mechanism 71. The second side of the first pushing component 51 and the first positioning mechanism 71 are not movable relative to each other. In the present embodiment, the second side of the first pushing component 51 and the first positioning mechanism 71 are integrally formed. The first end cap 12 of headrail 10 comprises a stop portion 122 on an inner side of the first end cap 12 for interacting with the first positioning mechanism 71, as shown in FIG. 7 and FIG. 11. When the first pushing component 51 is driven to rotates about the transmission shaft 30, the stop portion 122 and the first positioning mechanism 71 together define a range of the movable region S, as shown in FIG. 13, which the first pushing component 51 is allowed to move within.

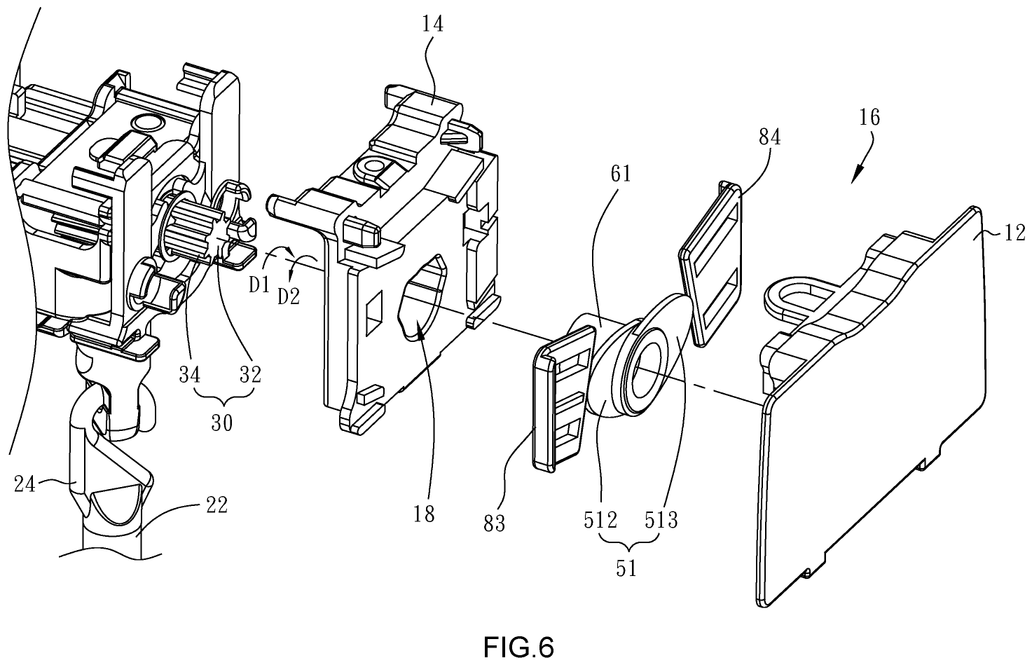

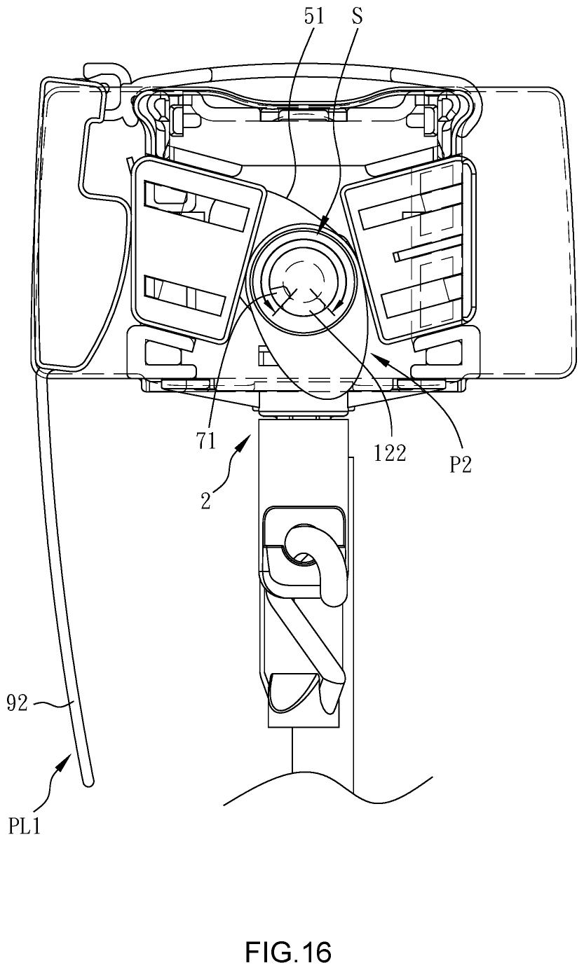

When the transmission shaft 30 drives the first pushing component 51 to rotate, the first pushing component 51 and the first positioning mechanism 71 would both move relative to the first end cap 12. For example, when the transmission shaft 30 rotates in a first rotating direction D1 (as shown in FIGS. 5-6) until the first positioning mechanism 71 abut against the stop portion 122, the first pushing component 51 and the first positioning mechanism 71 cannot move further (as shown in FIG. 2) and therefore a first end of the movable region S is defined. For ease of interpretation, the position of the first pushing component 51 in FIG. 2 is defined as a first limit position P1. If the transmission shaft 30 is driven to rotate in an opposite direction (i.e., a second direction D2 shown in FIGS. 5 and 6) until the first positioning mechanism 71 abut against the stop portion 122, the first pushing component 51 and the first positioning mechanism 71 cannot move further (as shown in FIG. 16) and therefore a second end of the movable region S is defined. The position of the first pushing component 51 in FIG. 16 is defined as a second limit position P2. When the first pushing component 51 is at a middle position of the movable region S as shown in FIG. 13, the first pushing component 51 could drive the light-blocking member 90 to pivot upwards. The position of the first pushing component 51 in FIG. 13 is defined as a pushing position P3. The naming of the first and second ends of the movable region S mentioned above is merely illustrative terms for ease of understanding and not limitations of the present disclosure. For example, the naming of the first end and the second end of the movable region S could be interchanged.

Based on the above descriptions, the first positioning mechanism 71 and the stop portion 122 on the first end cap 12 define the range of the movable region S for the first pushing component 51. The movable region S for the first pushing component 51 could be adjusted according to different design considerations. In the present embodiment, the movable region S is configured to be a curved region about 240 degrees surrounding the transmission shaft. In other embodiments, the movable region S could be designed a region of other suitable degrees surrounding the transmission shaft 30. In other embodiments, instead of providing the stop portion 122 on the first end cap 12 as mentioned above, the stop portion 122 can be also provided on other components of the headrail 10. For example, the stop portion 122 can be provided on the frame 11 or on the first base 14 of the headrail 10 (not shown) and the position of the first positioning mechanism 71 is adjusted accordingly to interact with the stop portion 122. In other embodiments, the stop portion 122 is provided on a suitable location on the working curve of the first pushing component 51 (not shown) and interferes with the first pushing component 51 to define the movable regions S. Thus, the first positioning mechanism 71 is not required in these embodiments.

As shown in FIGS. 5-10, the first clutch 61 is coupled between the transmission shaft 30 and the first pushing component 51 so as to engage or disengage the transmission shaft 30 and the first pushing component 51. In the present embodiment, the first clutch 61 and the first pushing component 51 are integrally formed. In other embodiments, the first clutch 61 and the first pushing component 51 can respectively comprise one or more components and be connected through suitable connection means, such as threaded fastening and snap-fitting.

The structure of the first clutch 61 and the connection relationship between the first clutch 61 and other components are illustrated in the following paragraphs. In this embodiment, the shape of the first clutch 61 is similar to a hollow cylinder formed by the clutch base 64 and the extending arm 66. As shown in FIGS. 6-10, the extending arm 66 of the first clutch 61 comprises a fixed end 662 and a free end 664. The fixed end 662 of the extending arm 66 is connected to the clutch base 64, and the free end 664 of the extending arm 66 is away from the fixed end 662 so that the free end 664 of the extending arm 66 is pivotable relative to the clutch base 64. The curved extending arm 66 surrounds the outer circumference of the transmission shaft 30 so as to engage with or disengage from the transmission shaft 30. In the current embodiment, an imaginary line passing through the fixed end 662 and the free end 664 of the extending arm 66 is substantially perpendicular to an axial direction of the shaft body 32 of the transmission shaft 30, wherein the axial direction of the shaft body 32 of the transmission shaft 30 is parallel to the longitudinal axis A of the headrail 10. An outer surface of the extending arm 66 and an outer surface of the clutch base 64 together form an outer circumference of the hollow cylinder mentioned above. The clutch base 64 fits around the shaft body 32 of the transmission shaft 30, and comprises a first toothed portion 642 provided on an inner surface of the clutch base 64. The extending arm 66 comprises a second toothed portion 666 provided on an inner surface of the extending arm 66 near the free end 664. The first toothed portion 642 and the second toothed portion 666 may be configured to engage with or disengage from the splines 34 of the transmission shaft 30.

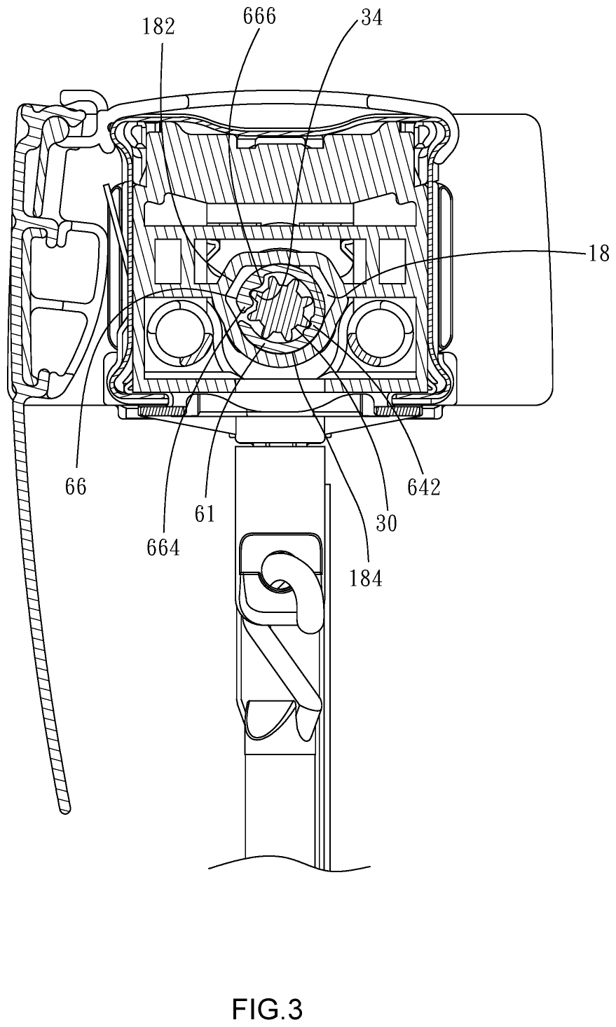

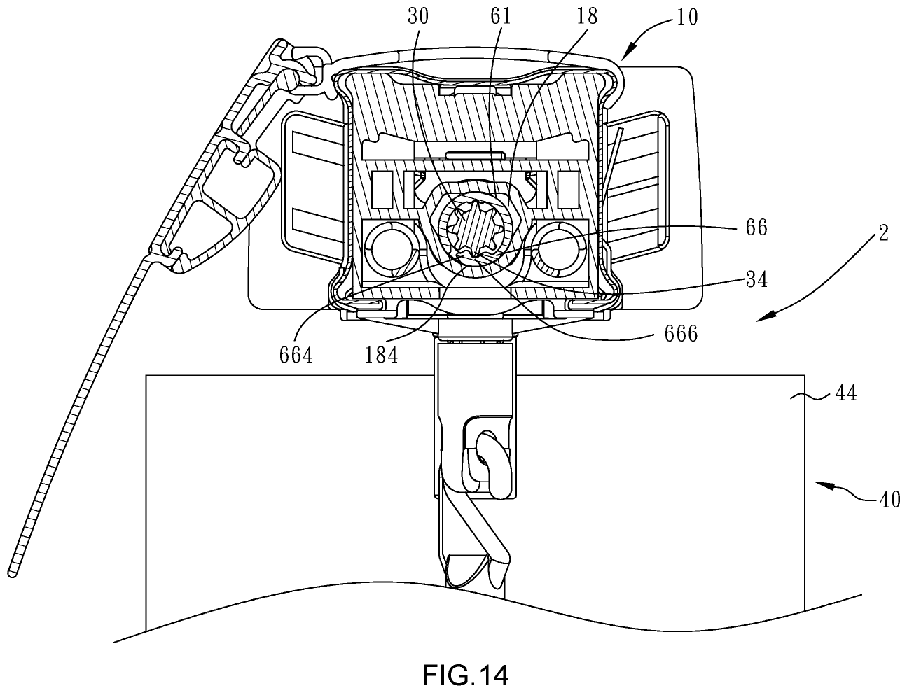

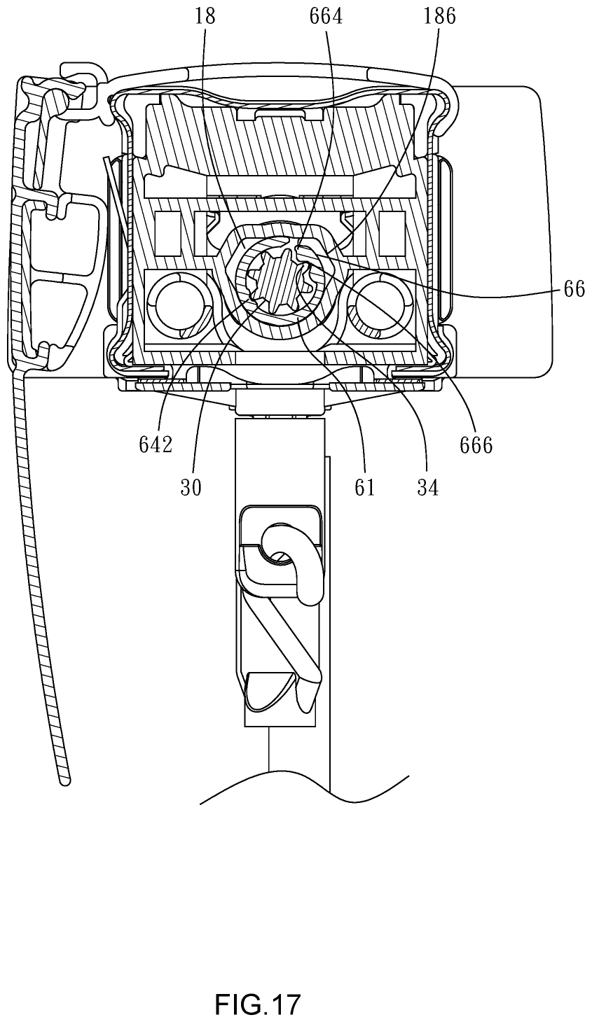

As shown in FIGS. 6-10, 12, and 14, at least a part of the extending arm 66 of the first clutch 61 is accommodated in the first restricting chamber 18 of the first base 14. The first restricting chamber 18 comprises a first non-restricting portion 182, a restricting portion 184, and a second non-restricting portion 186. The restricting portion 184 is between the first non-restricting portion 182 and the second non-restricting portion 186. When the first clutch 61 is received in the first restricting chamber 18, an inner surface of the restricting portion 184 is configured to be adjacent to the outer circumference of the hollow cylindrical first clutch 61. Inner surfaces of the first non-restricting portion 182 and the second non-restricting portion 186 are separated from the outer circumference of the first clutch 61 for a suitable distance. When the transmission shaft 30 drives the first clutch 61 to move and the extending arm 66 is accommodated in the restricting portion 184, as shown in FIG. 14, the free end 664 of the extending arm 66 is restricted between the transmission shaft 30 and the inner surface of the restricting portion 184. When the free end 664 of the extending arm 66 is restricted, the second toothed portion 666 of the extending arm 66 is engaged with the splines 34 of the transmission shaft 30, and therefore the transmission shaft 30 may drive the first clutch 61 to rotate. When the extending arm 66 of the first clutch 61 is accommodated in the first non-restricting portion 182 (as in FIG. 3) or the second non-restricting portion 186 (as in FIG. 17), the free end 664 of the extending arm 66 could pivot outwards into the first non-restricting portion 182 or the second non-restricting portion 186, both of which are deliberately separated from the extending arm 66 of the first clutch 61 by a suitable distance for receiving at least a part of the free end 664 of the extending arm 66. When the free end 664 of the extending arm 66 pivots outward, the second toothed portion 666 of the extending arm 66 is disengaged from the splines 34 of the transmission shaft 30, and the first toothed portion 642 of the clutch base 64 may also be configured to disengage from the splines 34 of the transmission shaft 30. In other words, there are slippage between the transmission shaft 30 and the first clutch 61, and the transmission shaft 30 cannot drive the first clutch 61 to rotate when the extending arm 66 of the first clutch 61 is accommodated in the first non-restricting portion 182 or the second non-restricting portion 186.

The interactions between the first clutch 61, the first pushing component 51, and the first restricting chamber 18 will be described in detail below.

Please refer to FIGS. 5-7, 13, and 14 again. When the transmission shaft 30 drives the first pushing component 51 to move to the pushing position P3 (as shown in FIG. 13), the extending arm 66 of the first clutch 61 is accommodated in the restricting portion 184 of the first restricting chamber 18 (as shown in FIG. 14). The extending arm 66 accommodated in the restricting portion 184 would be restricted from pivoting. Because the second toothed portion 666 of the extending arm 66 is engaged with the splines 34 of the transmission shaft 30, the transmission shaft 30 may drive the first pushing component 51 to move through the first clutch 61.

As shown in FIGS. 1-3, when the transmission shaft 30 drives the first pushing component 51 to move to the first limit position P1 (i.e., the first end of the movable region S), the extending arm 66 of the first clutch 61 is accommodated in the first non-restricting portion 182 of the first restricting chamber 18. If the transmission shaft 30 is still being driven to rotate in the first rotating direction D1, the free end 664 of the extending arm 66 of the first clutch 61 would pivot outwards in the first non-restricting portion 182. The second toothed portion 666 of the extending arm 66 and/or the first toothed portion 642 of the clutch base 64 would no longer engage with the splines 34 of the transmission shaft 30. Because of the slippage between the transmission shaft 30 and the first clutch 61, the first pushing component 51 would not be moved by the transmission shaft 60 and stay at substantially the first limit position P1 (i.e., the first end of the movable region S).

Similarly, when the transmission shaft 30 drives the first pushing component 51 to move to the second limit position P2 (i.e., the second end of the movable region S), as shown in FIGS. 15-17, the extending arm 66 of the first clutch 61 is accommodated in the second non-restricting portion 186 of first restricting chamber 18. If the transmission shaft 30 is still being driven to rotating in the second rotating direction D2, the free end 664 of the extending arm 66 of the first clutch 61 would pivot outwards in the second non-restricting portion 186. The second toothed portion 666 of the extending arm 66 and/or the first toothed portion 642 of the clutch base 64 would no longer engage with the splines 34 of the transmission shaft 30. Because of the slippage between the transmission shaft 30 and the first clutch 61, the first pushing component 51 would not be moved by the transmission shaft 60 and stay at substantially the second limit position P2 (i.e., the second end of the movable region S).

In summary, when the first pushing component 51 is moved to the first limit position P1 (i.e., the first end of the movable region S) or the second limit position P2 (i.e., the second end of the movable region S), the extending arm 66 of the first clutch 61 would be correspondingly accommodated in the first non-restricting portion 182 or the second non-restricting portion 186, whereby to disengage the first clutch 61 from the transmission shaft 30. When the first pushing component 51 is located at positions other than the first and second limit positions P1 and P2, the extending arm 66 of the first clutch 61 would be accommodated in the restricting portion 184, whereby to engage the first clutch 61 with the transmission shaft 30.

In other embodiments, the first restricting chamber 18 may comprise the restricting portion 184 and only one of the first non-restricting portion 182 and the second non-restricting portion 186 (not shown). For example, when the first restricting chamber 18 comprises the restricting portion 184 and the first non-restricting portion 182, but does not comprise the second non-restricting portion 186. When the first pushing component 51 is moved to the first end of the movable region S (i.e., the first pushing component 51 is moved to the first limit position P1) and the extending arm 66 of the first clutch 61 is accommodated in the first non-restricting portion 182, the first clutch 61 is disengaged from the transmission shaft 30. When the first pushing component 51 is located at other positions in the movable region S, the first clutch 61 is engaged with the transmission shaft 30. In another embodiment, the first restricting chamber 18 comprises the restricting portion 184 and the second non-restricting portion 186, but does not comprise the first non-restricting portion 182. When the first pushing component 51 is moved to the second end of the movable region S (i.e., the first pushing component 51 is moved to the second limit position P2) and the extending arm 66 of the first clutch 61 is accommodated in the second non-restricting portion 186, the first clutch 61 is disengaged from the transmission shaft 30. When the first pushing component 51 is located at other positions in the movable region S, the first clutch 61 is engaged with the transmission shaft 30.

In other embodiments, the first clutch 61 could be engaged with or disengaged from the transmission shaft 30 by other suitable components. For example, the first clutch 61 may comprise a torque limiter. The torque limiter has a predetermined bearable torque value, and provides the clutching function (i.e., engaging and disengaging) according to whether the torque applied thereon is greater than the predetermined bearable torque value. When the torque applied to this torque limiter by the transmission shaft 30 is less than the predetermined bearable torque value, the transmission shaft 30 is engaged with the first clutch 61, e.g., the splines 34 of the transmission shaft 30 is engaged with the first toothed portion 642 and the second toothed portion 666 of the first clutch 61. When the first pushing component 51 is at the first limit position P1 or the second limit position P2, the first positioning mechanism 71 would abut against the stop portion 122. The first clutch 61 is restricted by the first positioning mechanism 71 and stay at the first limit position P1 or the second limit position P2 even if the transmission shaft 30 keeps driving the first clutch 61 in the same rotating direction. When the torque applied to the first clutch 61 by the rotating transmission shaft 30 increases to be greater than the predetermined torque value, the extending arm 66 would be pushed outwards by the splines 34 of the transmission shaft 30 and there are slippages between the transmission shaft 30 and the first clutch 61. The first clutch 61 is therefore disengaged from the transmission shaft 30 and the first pushing component 51 would not be moved further. Moreover, when the clutching function of the first clutch is realized with the torque limiter, the first non-restricting portion 182, the restricting portion 184, and the second non-restricting portion 186 of the first restricting chamber 18 and the first base in the previous embodiments could be omitted. By changing the materials, shapes, and sizes of the clutch base 64 and/or the extending arm 66, the predetermined bearable torque value could be adjusted to meet different design considerations.

As shown in FIGS. 4, 5, and 13, the front cover plate 92 of the light-blocking member 90 extends along the longitudinal axis of the headrail 10. A length of the front cover plate 92 may be configured to be close to a length of the headrail 10. A top end of the front cover plate 92 is pivotally connected to a side of the frame 11 of the headrail 10, whereby the front cover plate 92 is movable between the blocking position PL1 (as shown in FIGS. 1, 2, 15, and 16) coving the gap 2 and the non-blocking position PL2 (as shown in FIGS. 4 and 13) revealing at least a part of the gap 2. In addition, the front cover plate 92 of the light-blocking member 90 is configured to not interfere with the slats 44. While the front cover plate 92 of the light-blocking member 90 is moved between the blocking position PL1 and the non-blocking position PL2, the front cover plate 92 of the light-blocking member 90 would not touch and therefore not damage the slats 44.

As shown in FIGS. 5-7 and 13, the first intermediate device 81 is configured to interact with the first pushing component 51. The first intermediate device 81 comprises a front moving block 83, which is accommodated and movable in the first operation space 16. The front moving block 83 is located between the first pushing component 51 and the front cover plate 92 of the light-blocking member 90. A side of the front moving block 83 may be pushed by the plate cam 512 of the first pushing component 51 and consequently another side of the front moving block 83 may push an inner surface of the front cover plate 92 of the light-blocking member 90 upwards or outwards.

The interactions between the transmission shaft 30, the first pushing component 51, the first intermediate device 81, and the light-blocking member 90 are illustrated in FIGS. 1 to 17.

When the transmission shaft 30 drives the first pushing component 51 to move from the limit positions P1 or P2 to the pushing position P3 (as shown in FIG. 13), the plate cam 512 of the first pushing component 51 would gradually push the front moving block 83 toward the front side of the headrail 10 (i.e., in a direction away from the transmission shaft 30). The front moving block 83 would push the front cover plate 92 of the light-blocking member 90 to pivot upwards or outwards from the blocking position PL1 toward the non-blocking position PL2. When the transmission shaft 30 drives the first pushing component 51 to move from the pushing position P3 to the limit positions P1 or P2, the plate cam 512 of the first pushing component 51 would rotate so that the front moving block 83 moves inwards or downwards (i.e., in a direction toward the transmission shaft 30). The front cover plate 92 of the light-blocking member 90 would pivot from the non-blocking position PL2 toward the blocking position PL1.

In the present embodiment, the first pushing component 51 pushes the front cover plate 92 to pivot from the blocking position PL1 to the non-blocking position PL2, and the front cover plate 92 pivots from the non-blocking position PL2 to the blocking position PL1 by the driving of its own weight. In other embodiments, the pivoting movement of the front cover plate 92 in both directions could be both driven by the first pushing component 51. For example, the two sides of the front moving block 83 of the first intermediate device 81 could be respectively connected to the inner surface of the front cover plate 92 and the first pushing component 51. The pivoting movements of the front cover plate 92 and the movement of the front moving block 83 are both driven by the first pushing component 51, e.g., either the pivoting movement of the front cover plate 92 of the light-blocking member 90 from the blocking position PL1 to the non-blocking position PL2 or the other way around is driven by the first pushing component 51.

In other embodiments, the light-blocking member 90 comprises a front cover plate 92 and a rear cover plate (not shown) pivotally provided on different sides of the frame 11 of the headrail 10, respectively. The first intermediate device 81 comprises a front moving block 83 and a rear moving block 84 respectively interacting with one of the cover plates. With the cover plates provided on both sides of the headrail 1, the light-blocking capability of the vertical blind 1 could be improved and the light passing through the gap 2 may be further reduced. The rear cover plate and the rear moving block 84 may be realized with components, structurers, interactions and/or mechanisms the same as or similar to the front cover plate 92 and the front moving block 83, and therefore will not be described in detail.

In other embodiments, the structure of the first intermediate device 81 could be further omitted so that the first pushing component 51 is configured to directly push the light-blocking member 90 to pivot. In this way, without losing the effect of the present disclosure, the vertical blind 1 could be realized with fewer parts and a reduced complexity.

When the vertical blind 1 is arranged as shown in FIGS. 1 and 2, the slats 44 of the slat assembly 40 are at the first closed position and at least part of the slats 44 are overlapped to block out the light. The front cover plate 92 of the light-blocking member 90 is not pushed upwards by the first pushing component 51 and/or the first intermediate device 81. The front cover plate 92 would naturally hang and stay at the blocking position PL1 to cover the gap 2. By rotating the wand 22 of the driving assembly 20 to drive the transmission shaft 30 to rotate, the slats 44 of the slat assembly 40 could be turned to the open position to let in the light. During the process of rotating the transmission shaft 30, not only the slats 44 of the slat assembly 40 would be driven to turn, the first clutch 61 and the first pushing component 51 would be also driven to rotate. The first pushing component 51 would consequently drive the front moving block 83 of the first intermediate device 81 to push the front cover plate 92 of the light-blocking member 90 to pivot upwards. When the slats 44 are turned to the open position shown in FIGS. 4 and 13, the first pushing component 51 is moved to the pushing position P3 for pushing the front cover plate 92 to the non-blocking position PL2 through the front moving block 83. The light would be allowed to pass through the gap 2 when the slats 44 are turned to the open position. Afterwards, if the wand 2 keeps being rotated in the same rotating direction, the slats 44 would be further turned toward the second closed position shown in FIGS. 15 and 16. The transmission shaft 30 drives the first pushing component 51 to move from the pushing position P3 to the second limit position P2. The front cover plate 92 of the light-blocking member 90 would then pivot from the non-blocking position PL2 back to the blocking position PL1 and cover the gap 2.

As shown in FIGS. 16 and 17, when the first pushing component 51 is moved to the second limit position P2, the first clutch 61 is disengaged from the transmission shaft 30. Even if the wand 22 is continuously being rotated in the same rotating direction to drive the transmission shaft 30, the extending arm 66 of the first clutch 61 staying at the second non-restricting portion 186 would disengage the first clutch 61 from the transmission shaft 30. The first pushing component 51 therefore stays at the second limit position P2 and the front cover plate 92 of the light-blocking member 90 also stays at the blocking position PL1.

Similarly, if the wand 22 is rotated in the opposite rotating direction to turn the slats 44 from the second closed position to the open position and then to the first closed position, the front cover plate 92 of the light-blocking member 90 would be correspondingly moved from the blocking position PL1 to the non-blocking position PL2 and then to the blocking position PL1. Accordingly, the first pushing component 51 would be driven to move from the second limit position P2 to the pushing position P3 and then to the first limit position P1. Please refer to FIGS. 2 and 3. When the first pushing component 51 stays at the first limit position P1, even if the wand 22 is continuously being rotated in this opposite rotating direction to drive the transmission shaft 30, the extending arm 66 of the first clutch 61 staying at the first non-restricting portion 182 would disengage the first clutch 61 from the transmission shaft 30. The first pushing component 51 therefore stays at the first limit position P1 and the front cover plate 92 of the light-blocking member 90 also stays at the blocking position PL1.

In the vertical blind 1 of the present disclosure, the driving assembly 20 is configured to move the light-blocking member 90 while turning the slats 44. Specifically, when the slats 44 are turned to the first closed position or the second closed position, the front cover plate 92 of the light-blocking member 90 would be moved to the blocking position PL1 to cover the gap 2. When the slats 44 are turned to the open position, the front cover plate 92 of the light-blocking member 90 would be moved to the non-blocking position PL2 to prevent from interfering with the slats 44. In addition, by providing the first clutch 61 between the transmission shaft 30 and the first pushing component 51, the driving assembly 20, the transmission shaft 30, and/or the pushing component 51 would not be damaged when the user overdrive the driving assembly 20.

In the present embodiment, the headrail 10 further comprises a second end cap 13 and a second base 15, as shown in FIG. 5. The second end cap 13 is provided at another end of the frame 11 opposite to the first end cap 12, and defines another boundary of the accommodating space 102. A second operation space 17 is defined between the second end cap 13 and the second base 15. Furthermore, the second base 15 comprises a second restricting chamber 19. In addition, the vertical blind 1 further comprises a second pushing component 52, a second clutch 62, a second positioning mechanism 72, and a second intermediate device 82. These second pushing component 52, second clutch 62, second positioning mechanism 72, and second intermediate device 82 are realized in the same or similar manner to the aforementioned first pushing component 51, first clutch 61, first positioning mechanism 71, and first intermediate device 81 at the opposite end of the headrail 10, e.g., the configurations may be configured to be mirrored. The structures and configurations of these components are substantially the same as or similar to those counterparts described above. The first and second pushing components 51 and 52 provided on both ends of the headrail 10 could collectively pivot the front cover plate 92 of the light-blocking member 90 outwards by the driving of the transmission shaft 30. Because the first and second pushing components 51 and 52 separated at different locations of the headrail 10 collectively pivot the front cover plate 92 of the light-blocking member 90, the entire front cover plate 92 would be pivot to substantially the same angle even if the slats 44 are stacked to one side or both sides of the headrail 10. The vertical blind 1 may be both functional and aesthetic.

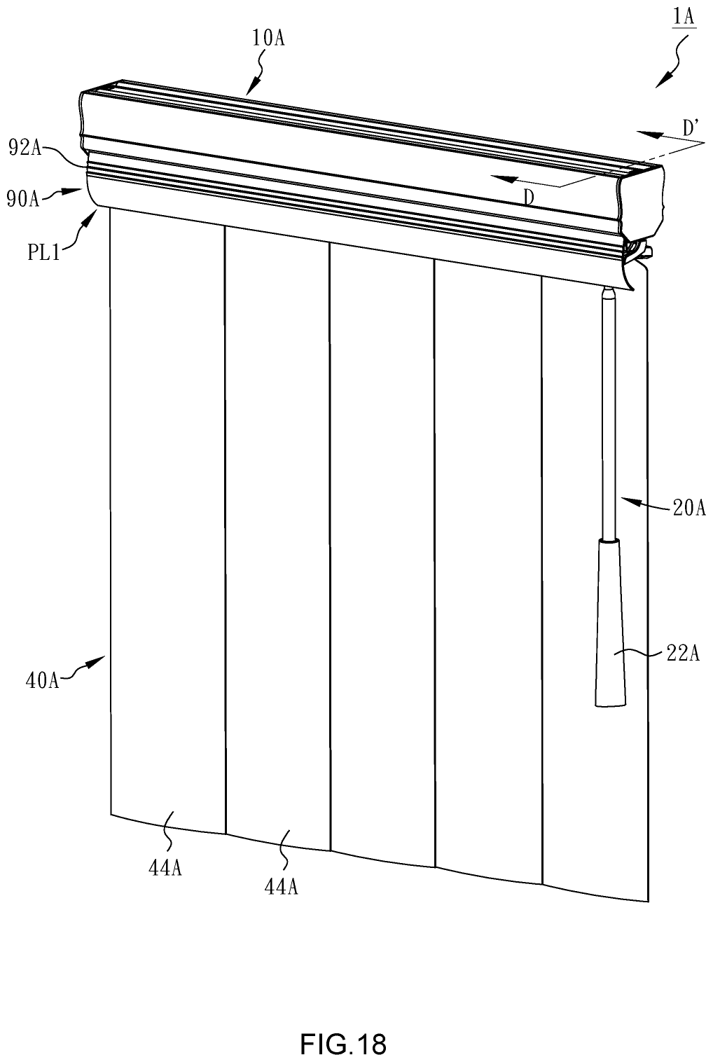

A second embodiment of a vertical blind 1A of the present disclosure is illustrated in FIGS. 18-27.

The vertical blind 1A comprises a headrail 10A, a driving assembly 20A, a transmission shaft 30A, a slat assembly 40A, a first pushing component 51A, a first clutch 61A, a first positioning mechanism 71A, a first intermediate device 81A, and a light-blocking member 90A. The configurations of the components of the present embodiment are similar to or the same as those of the first embodiment. The headrail 10A comprises a first end cap 12A and a first base 14A. The first clutch 61A is provided between the first base 14A and the first end cap 12A. The first pushing component 51A is coupled with the transmission shaft 30A through the first clutch 61A. The first positioning mechanism 71A is configured to interact with the first clutch 61A. The first intermediate device 81A is located between the light-blocking member 90A and the first pushing component 51A.

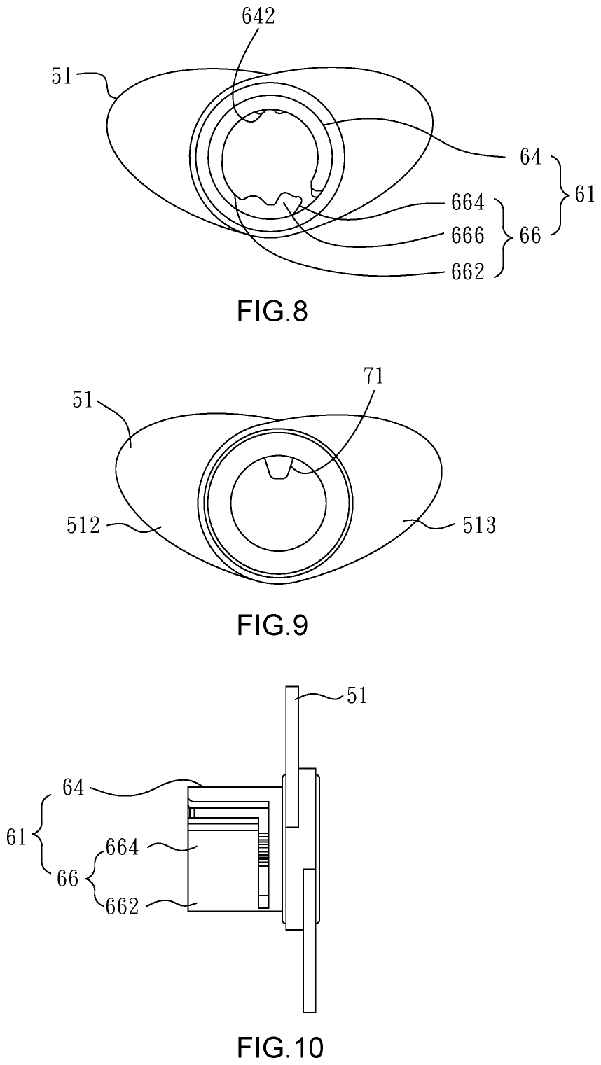

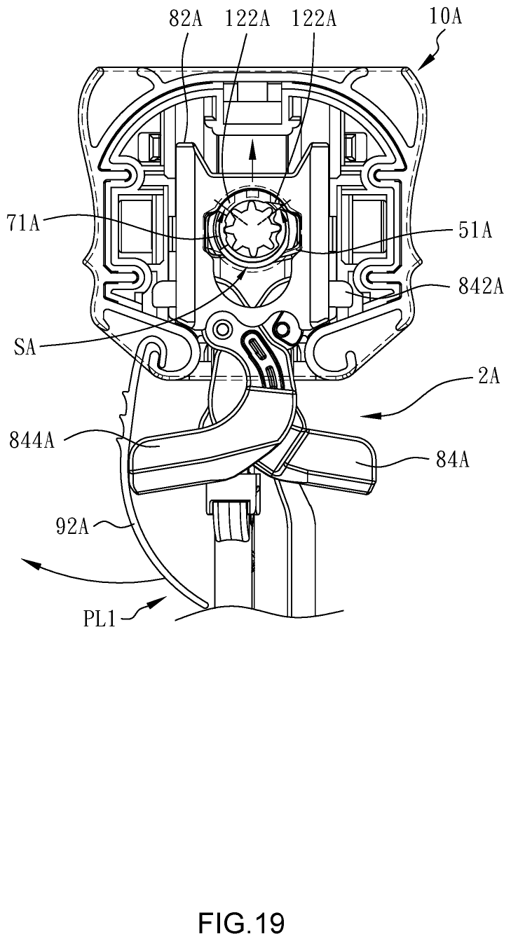

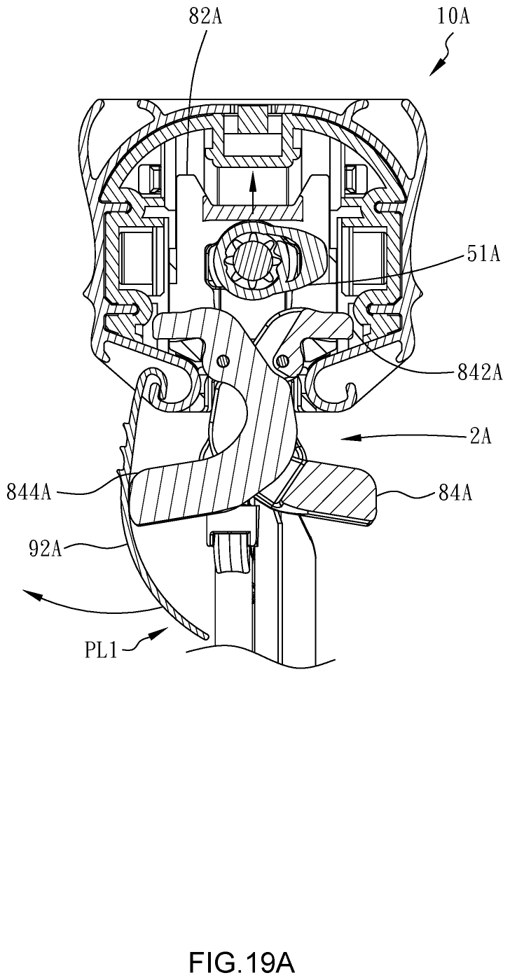

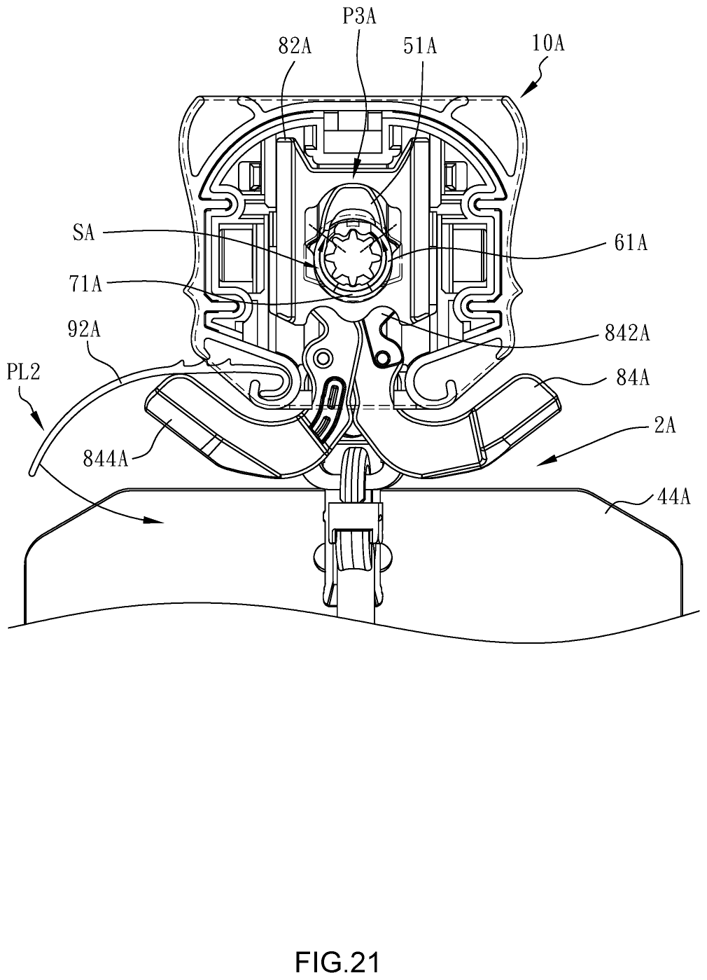

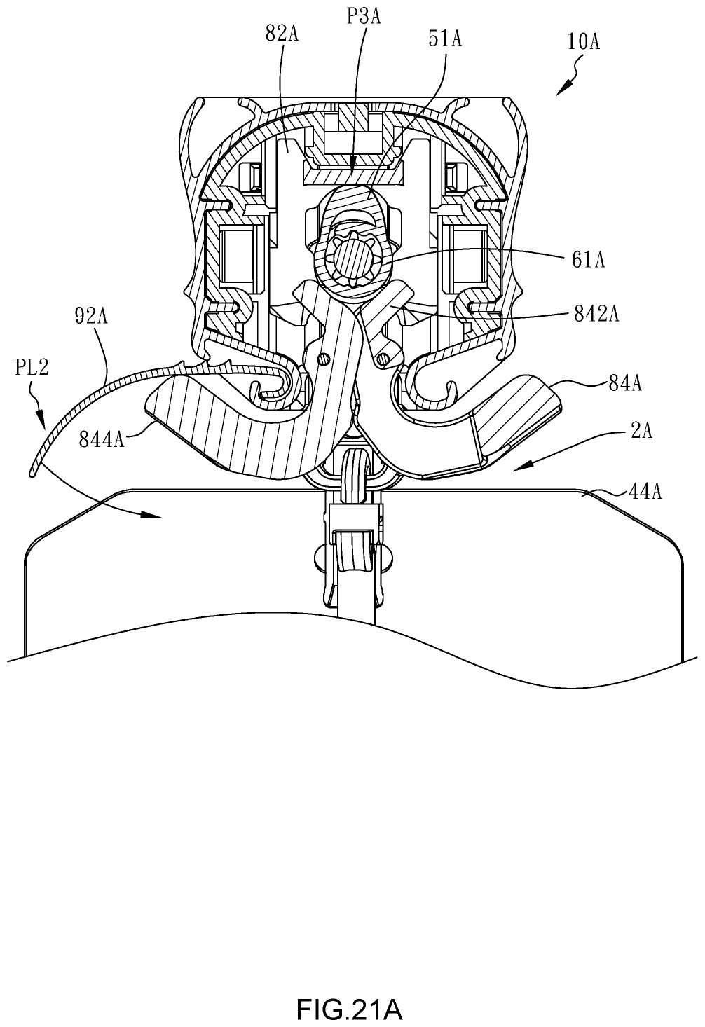

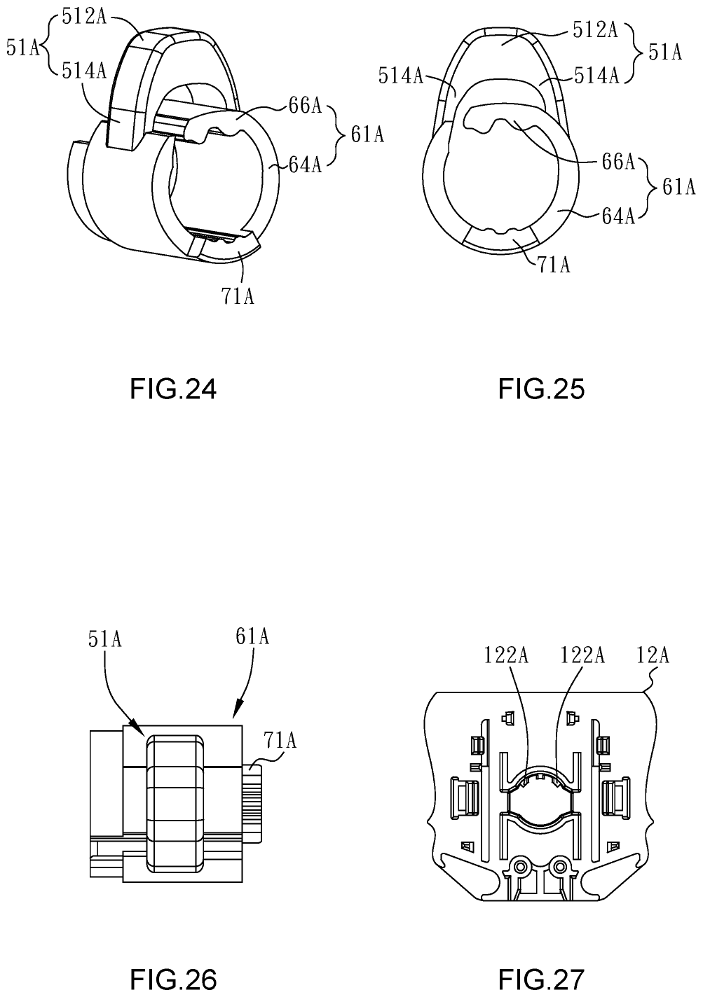

In the second embodiment, the first pushing component 51A and the first clutch 61A are configured to be integrally formed and not movable relative to each other. While the plate cams 512 and 513 of the first pushing component 51 in the first embodiment are provided at an end of the hollow cylinder formed by the first clutch 61 (as shown in FIGS. 8-10), a cam 512A of the first pushing component 51A in the second embodiment is provided on an outer circumference of a hollow cylinder formed by the first clutch 61A, as shown in FIGS. 24-26. The cam 512A comprises two connecting portions 514A connected to an outer surface of a clutch base 64A of the first clutch 61A. A curved extending arm 66A of the first clutch 61A is located between the connecting portions 514A of the cam 512A. As shown in FIGS. 23-27, the first positioning mechanism 71A is provided at an end of the hollow cylinder formed by the first clutch 61A, and is configured to interact with two stop portions 122A of the first end cap 12A, whereby to define a movable region SA for the first pushing component 51A, as shown in FIGS. 19 and 21.

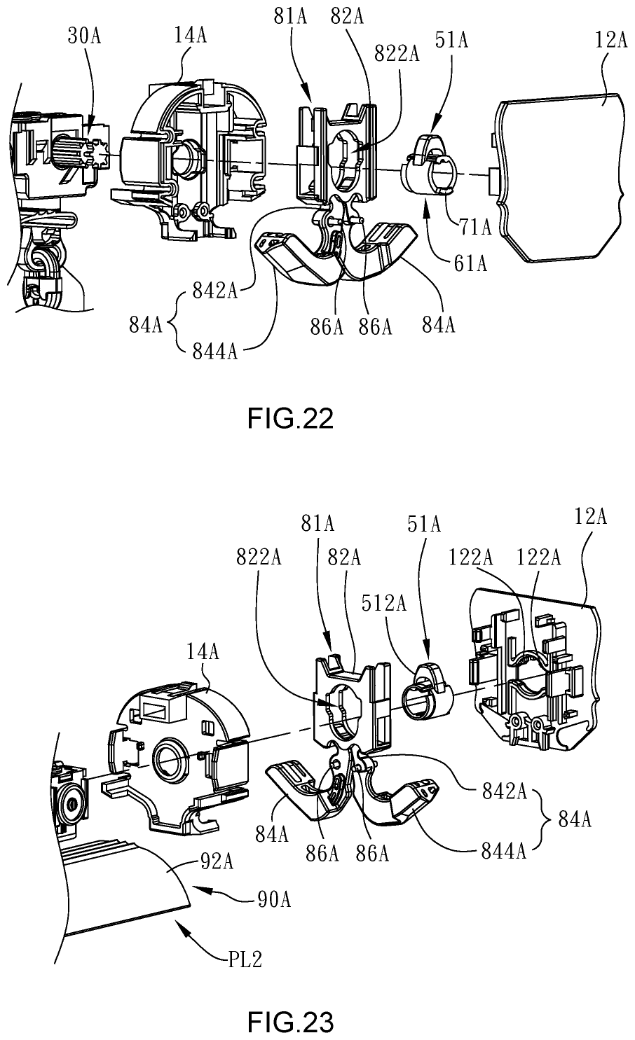

As shown in FIGS. 22 and 23, the first intermediate device 81A comprises a driving ring 82A, two swing arms 84A, and two pivots 86A. The driving ring 82A may be configured to be substantially cuboidal or other suitable shape for coupling with other components, and comprises a through hole 822A for fitting around the transmission shaft 30A. The through hole 822A is configured to accommodate the first pushing component 51A. When the first pushing component 51A rotates in the through hole 822A, the cam 512A of the first pushing component 51A drives the driving ring 82A to move vertically. Each of the pivots 86A passes through one of the swing arms 84A, and two ends of each of the pivots 86A are respectively connected to the first end cap 12A and the first base 14A. Each of the swing arms 84A comprises an upper segment 842A above the pivot 86A and a lower segment 844A below the pivot 86A. The upper segment 842A of the swing arm 84A is engaged with the driving ring 82A, and the lower segment 844A is configured to push the light-blocking member 90A. When the first pushing component 51A drives the driving ring 82A to move upwards from a lower position (as shown in FIGS. 19 and 19A) to a higher position (as shown in FIGS. 21 and 21A), the lower segment 844A of the swing arms 84A is driven to pivot upwards around the pivots 86A. When the lower segment 844A of the swing arm 84A pivots upwards, the lower segment 844A of the swing arm 84A pushes an inner surface of a front cover plate 92A of the light-blocking member 90A to move the front cover plate 92A toward the non-blocking position PL2, as shown in FIGS. 21 and 21A.

The operations of the slat assembly 40A and the light-blocking member 90A in the second embodiment will be illustrated in the following paragraphs.

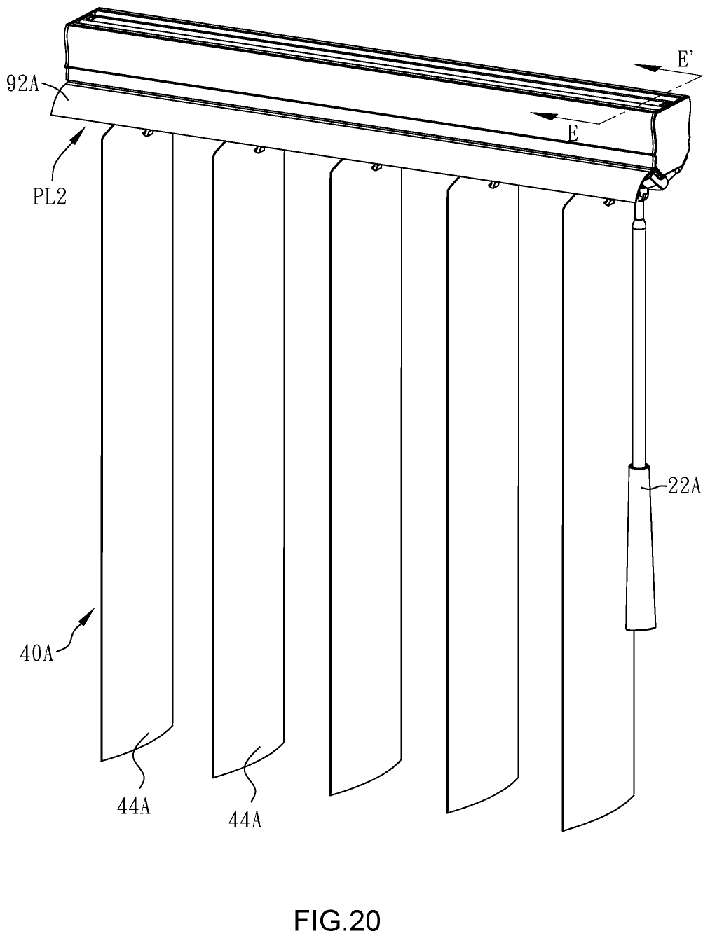

In FIGS. 18 and 19, the slats 44A of the slat assembly 40A of the vertical blind 1A are at the first closed position, and the slats 44A overlap at least partially to block out light. The front cover plate 92A of the light-blocking member 90A is not moved upwards by the first pushing component 51A and the first intermediate device 81A, and the front cover plate 92A of the light-blocking member 90A stays at the blocking position PL1 to cover the gap 2A. After that, by rotating the wand 22A of the driving assembly 20A for driving the transmission shaft 30A to rotate, the slats 44A of the slat assembly 40A are turned to the open position shown in FIGS. 20-21. As shown in FIGS. 22 and 23, the rotation of the transmission shaft 30A turns the slats 44A of the slat assembly 40A and also drives the first clutch 61A and the first pushing component 51A to move. When the first pushing component 51A drives the driving ring 82A of the first intermediate device 81A to move upwards, the driving ring 82A pushes the upper segment 842A of the swing arm 84A and therefore moves the lower segment 844A of the swing arm 84A upwards. The pivoting movement of the swing arm 84A would push and move the front cover plate 92A of the light-blocking member 90A. Once the slats 44A are controlled to turn to the open position shown in FIG. 20, the front cover plate 92A of the light-blocking member 90A would be also moved to the non-blocking position PL2 by the pushing of the corresponding swing arm 84A. By continuously rotating the wand 22A in the same rotating direction, the slats 44A would be further turned toward the second closed position (not shown), and the first pushing component 51A would be driven to leave the pushing position P3A. As a result, the driving ring 82A would move downward and the swing arm 84A pivots downwards. The front cover plate 92A of the light-blocking member 90A would also move from the non-blocking position PL2 to the blocking position PL1. The front cover plate 92A of the light-blocking member 90A would cover the gap 2 again, as shown in FIG. 19.

The connections and the interactions between the components of the second embodiment may be configured to be the same as or similar to the counterparts in the first embodiment. For example, the configuration of the first clutch 61A may be realized with the first clutch 61 in the first embodiment, and therefore the integrally formed first pushing component 51A and first clutch 61A operate in the same way as in the first embodiment.

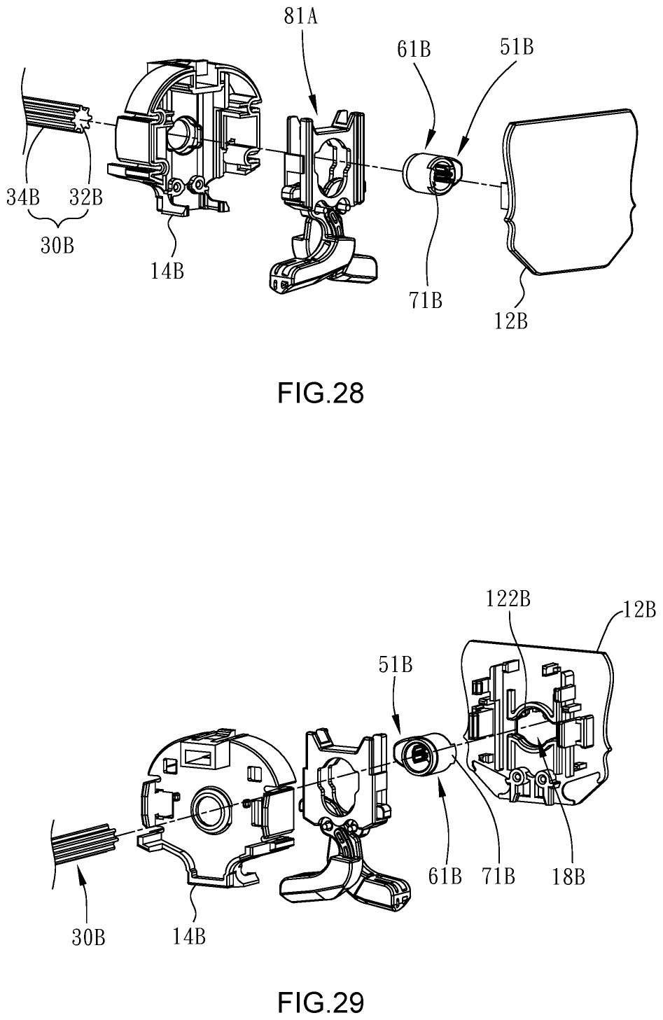

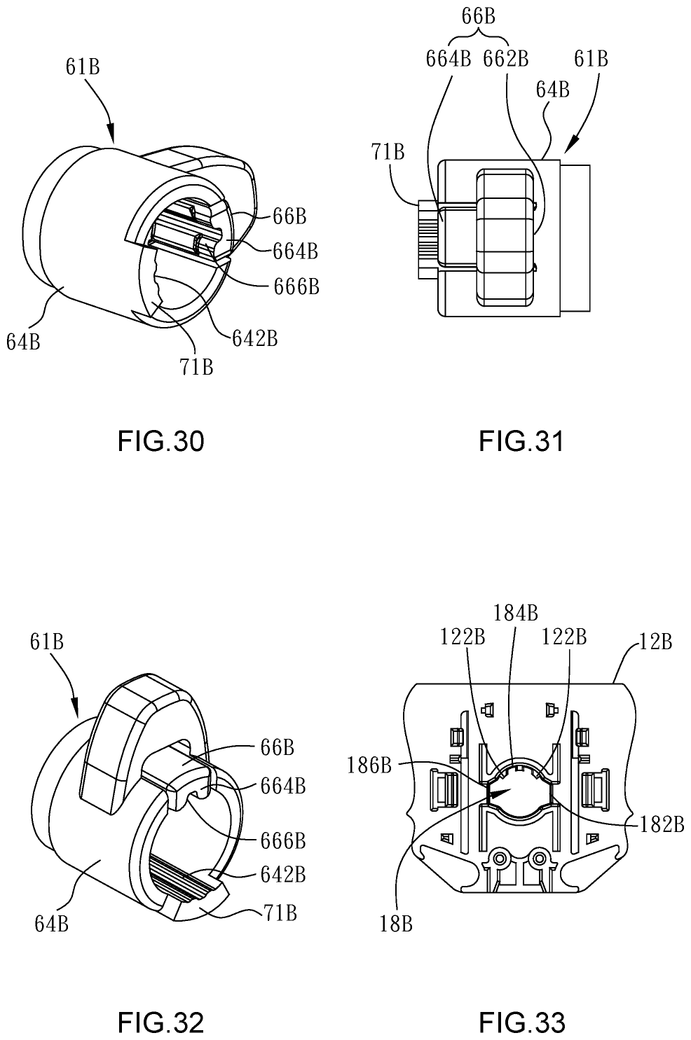

The structures and the connections of the first clutch and the first restricting chamber of the vertical blind may also be realized with other variations in other embodiments. FIGS. 28-33 show another embodiment of a transmission shaft 30B, a first base 14B, the first intermediate device 81A, a first pushing component 51B, a first clutch 61B, a first positioning mechanism 71B, and a first end cap 12B. The configuration of each of the above components will be described in detail in the following paragraphs.

Please refer to FIGS. 28-33. The first clutch 61B comprises a clutch base 64B and an extending arm 66B, which collectively form a shape similar to a hollow cylinder. The extending arm 66B comprises a free end 664B and a fixed end 662B. The fixed end 662B is connected to the clutch base 64B, and the free end 664B extends along an axial direction of the hollow cylinder and may pivot relative to the clutch base 64B. In the present embodiment, an imaginary line passing through the fixed end 662B and the free end 664B is substantially parallel to an axial direction of the shaft body 32B of the transmission shaft 30B. The fixed end 662B is located at a position away from the first end cap 12B, and the free end 664B is located at a position adjacent to the first end cap 12B. A shaft body 32B of the transmission shaft 30B passes through the clutch base 64B. The clutch base 64B comprises a first toothed portion 642B provided on an inner surface of the clutch base 64B. The first toothed portion 642B is engaged with splines 34B of the transmission shaft 30B. The extending arm 66B comprises a second toothed portion 666B on an inner surface of the extending arm 66B near the free end 664B. The second toothed portion 666B is configured to engage with or disengage from the splines 34B for providing a clutching function. The first positioning mechanism 71B is provided at an end of the hollow cylinder formed by the first clutch 61B and adjacent to the first end cap 12B. The first end cap 12B comprises two stop portions 122B on an inner side of the first end cap 12B. The stop portions 122B interact with the first positioning mechanism 71B to define a movable region (not shown) for the first pushing component 51B.

The first end cap 12B comprises a first restricting chamber 18B provided corresponding to the free end 664B of the extending arm 66B of the first clutch 61B. Specifically, at least a part of the free end 664B of the extending arm 66B of the first clutch 61B is accommodated in the first restricting chamber 18B. The first restricting chamber 18B is formed on the first end cap 12B, and comprises a first non-restricting portion 182B, a restricting portion 184B, and a second non-restricting portion 186B provided on an inner wall of the first restricting chamber 18B. The restricting portion 184B is located between the first non-restricting portion 182B and the second non-restricting portion 186B. A surface of the restricting portion 184B of the first restricting chamber 18B is substantially adjacent to an outer circumference of the hollow cylinder formed by the first clutch 61B. Surfaces of the first non-restricting portion 182B and the second non-restricting portion 186B are separated from the outer circumference of the hollow cylinder formed by the first clutch 61B with a suitable distance. When the transmission shaft 30B drives the first clutch 61B to move the free end 664B of the extending arm 66B to the restricting portion 184B, the free end 664B of the extending arm 66B would be restricted by the transmission shaft 30B and the surface of the restricting portion 184B from pivoting. The second toothed portion 666B of the extending arm 66B would keep engaged with the splines 34B of the transmission shaft 30B. Because the surfaces of the first non-restricting portion 182B and the second non-restricting portion 186B are separated from the first clutch 61B with a suitable distance, the free end 664B of the extending arm 66B could pivot outwards in the first non-restricting portion 182B or the second non-restricting portion 186B. When the free end 664B of the extending arm 66B pivots outward, the second toothed portion 666B of the extending arm 66B is disengaged from the splines 34B of the transmission shaft 30B, and the first toothed portion 642B may be even disengaged from the splines 34B of the transmission shaft 30B. There are slippages between the transmission shaft 30B and the first clutch 61B when the free end 664B of the extending arm 66B is located at the first non-restricting portion 182B or the second non-restricting portion 186B.

The differences between the present embodiment and the previous embodiments are mainly at the structures and connection relationships of the first clutch 61B and the first restricting chamber 18B, especially the extending direction of the extending arm 66B of the first clutch 61B. The clutching mechanism of the first clutch 61B is similar to the counterparts in previous embodiments.

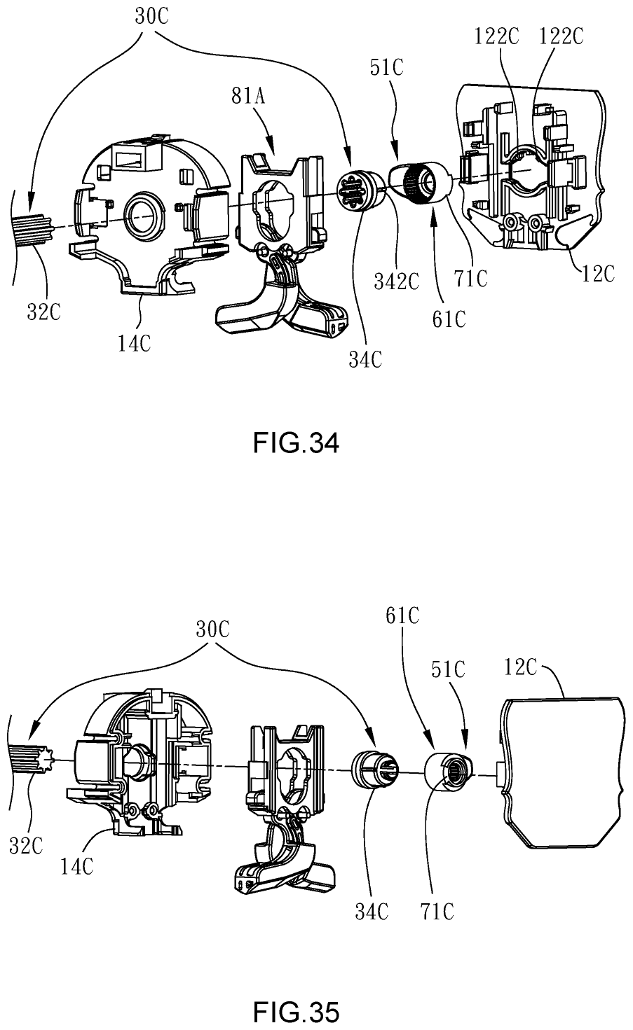

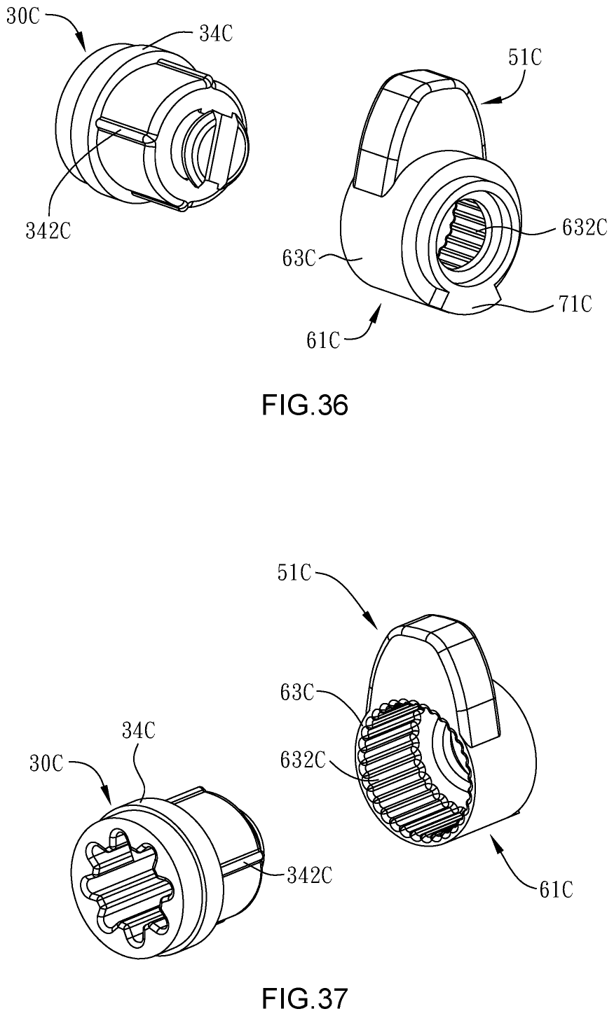

FIGS. 34-37 show another embodiment of a transmission shaft 30C, a first base 14C, the first intermediate device 81A, a first pushing component 51C, a first clutch 61C, a first positioning mechanism 71C, and a first end cap 12C. The configuration of the interactions of the above components will be described in detail in the following paragraphs.

The transmission shaft 30C comprises a shaft body 32C and a sleeve 34C. The sleeve 34C fits around the shaft body 32C in a manner that the sleeve 34C is non-rotatable relative to the shaft body 32C. The sleeve 34C comprises an outer ridge structure 342C, which comprising one or more ribs extending in an axial direction of the transmission shaft 30C. The first clutch 61C comprises a main body 63C, and the main body 63C comprises an inner toothed structure 632C. The sleeve 34C and the main body 63C are correspondingly provided, and the outer ridge structure 342C of the sleeve 34C is engaged with the inner toothed structure 632C of the main body 63C. The first positioning mechanism 71C is fixedly provided on a side of the main body 63C adjacent to the first end cap 12C. The first end cap 12C comprises two stop portions 122C on an inner side of the first end cap 12C. The stop portions 122C interact with the first positioning mechanism 71C to define a movable region (not shown) for the first pushing component 51C.

The operation of the first clutch 61C is similar to that of the aforementioned torque limiter. When the first pushing component 51C is located at a first limit position or a second limit position, the first positioning mechanism 71C abuts against one of the stop portions 122C. Because the first positioning mechanism 71C and the first clutch 61C are non-rotatable relative to each other, the first clutch 61C would also be restricted by the first positioning mechanism 71C and stay at its current position even if the transmission shaft 30C keeps being driven to rotate in the same rotating direction. When the torque applied to main body 63C of the first clutch 61C by the rotating transmission shaft 30C through the sleeve 34C increases to be greater than a predetermined torque value, at least one of the sleeve 34C and the main body 63C deforms temporarily. As a result, the outer ridge structure 342C and the inner toothed structure 632C slip relatively and are disengaged. When the torque applied to the main body 63C of the first clutch 61C through the sleeve 34C is less than the predetermined torque value (e.g., when the first positioning mechanism 71C does not abut against the stop portions 122C), the outer ridge structure 342C of the sleeve 34C and the inner toothed structure 632C of the main body 63C are engaged.

To provide a better clutching function, the outer ridge structure 342C of the sleeve 34C and the inner toothed structure 632C of the main body 63C may be realized with rounded profiles and other suitable shapes.

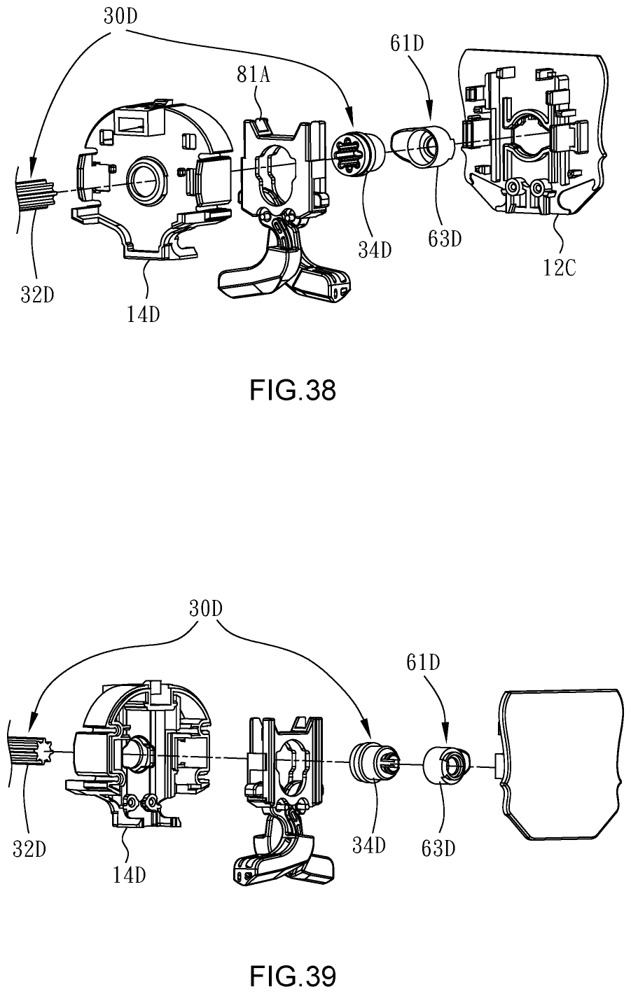

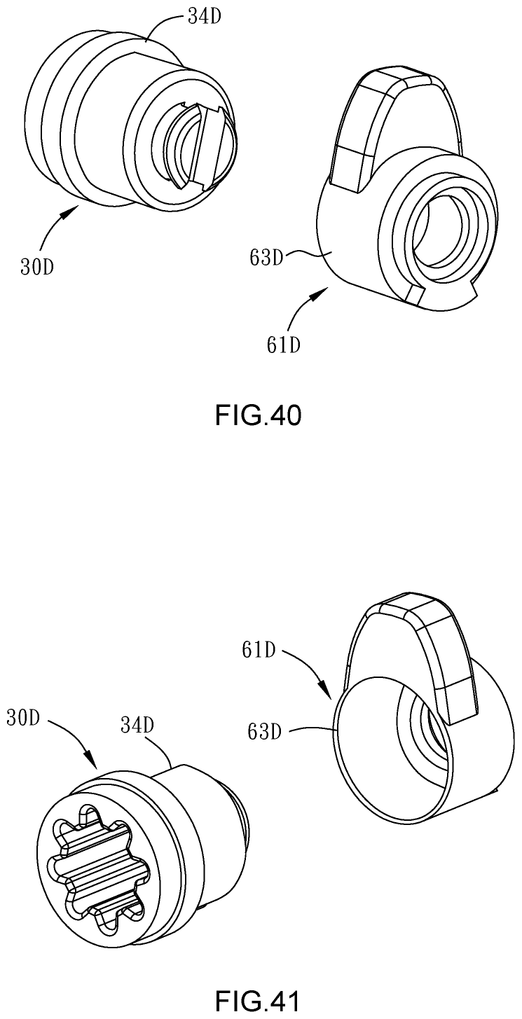

FIGS. 38-41 show another embodiment of a transmission shaft 30D, the first base 14D, the first intermediate device 81A, a first clutch 61D, and a first end cap 12C.

The transmission shaft 30D comprises a shaft body 32D and a sleeve 34D. The sleeve 34D fits around the shaft body 32D in a manner that the sleeve 34D is non-rotatable relative to the shaft body 32D. The first clutch 61D comprises a main body 63D. The sleeve 34D and the main body 63D are provided correspondingly. In this embodiment, the sleeve 34D is realized with a cylindrical circumference without an outer ridge structure. The main body 63D of the first clutch 61D is realized with a recess within a cylindrical inner wall, but without an inner toothed structure formed therein. The sleeve 34D is configured to be tightly fitted in the main body 63D. The sleeve 34D and the main body 63D would not slip relatively unless the torque applied to the main body 63D of the first clutch 61D by the transmission shaft 30D through the sleeve 34D is greater than the static friction between the sleeve 34D and the main body 63D. When the sleeve 34D and the main body 63D slip relatively, the sleeve 34D and the main body 63D are disengaged. In other words, a predetermined torque value in the present embodiment is determined by the static friction between the sleeve 34D and the main body 63D.

In other embodiments, the static friction between the sleeve 34D and the main body 63D could be adjusted by utilizing different materials for the contact surfaces of these two components. For example, the contact surfaces of the sleeve 34D and the main body 63D could be respectively realized with rigid plastic, soft plastic, and/or other suitable materials to obtain the required static friction.

The embodiments described above are only some exemplary embodiments of the present disclosure. All equivalent structures which employ the concepts disclosed in this specification and the appended claims should fall within the scope of the present disclosure.

What is claimed is:

1. A vertical blind, comprising:
a headrail;
a transmission shaft located in the headrail;
a plurality of slats connected to the transmission shaft and located below the headrail with a gap formed between the slats and the headrail, wherein the slats are movable along the transmission shaft and driven to turn by the transmission shaft;
a driving assembly connected to the transmission shaft for driving the transmission shaft to turn the slats between a first closed position and a second closed position, wherein an open position is defined between the first and second closed positions;
a first clutch connected to the transmission shaft;
a first pushing component connected to the transmission shaft through the first clutch to be driven to move between a first end and a second end of a movable region; and
a light-blocking member configured to be driven by the first pushing component to move from a blocking position coving the gap to a non-blocking position revealing at least a part of the gap;
wherein when the slats are at the first closed position, the light-blocking member is located at the blocking position;
wherein when the slats are turned from the first closed position to the open position, the transmission shaft drives the first pushing component to push the light-blocking member to move towards the non-blocking position;
wherein when the transmission shaft is driven to rotate in a first direction, the first pushing component is moved toward the first end of the movable region;
wherein when the transmission shaft is driven to rotate in a second direction opposite to the first direction, the first pushing component is moved toward the second end of the movable region;
wherein when the first pushing component has been moved to the first end of the movable region and the transmission shaft keeps being driven to rotate in the first direction, the first clutch prevents the transmission shaft from further driving the first pushing component, whereby the first pushing component stays at substantially the first end of the movable region.

2. The vertical blind of claim 1, wherein when the first pushing component has been moved to the first end of the movable region, the transmission shaft keeps being driven to rotate in the first direction, and a torque applied to the first clutch from the transmission shaft is higher than a predetermined torque value, the first clutch is disengaged from the transmission shaft.

3. The vertical blind of claim 1, wherein the transmission shaft comprises a shaft body and a plurality of splines; the splines are equally spaced and provided on a circumference of the shaft body along an axial direction of the shaft body of the transmission shaft; the first clutch comprises a clutch base and an extending arm; the extending arm comprises a fixed end connected to the clutch base and a free end away from the fixed end so that the extending arm is pivotable relative to the clutch base; the shaft body passes through the clutch base; the extending arm has a toothed portion for engaging with the splines.

4. The vertical blind of claim 3, wherein, when the first pushing component has been moved to the first end of the movable region and the transmission shaft keeps being driven to rotate in the first direction, the splines push the free end of the extending arm pivoting upwards, whereby the toothed portion of the extending arm of the first clutch is disengaged from the splines of the transmission shaft to prevent the transmission shaft from further driving the first pushing component.

5. The vertical blind of claim 3, wherein the headrail comprises a restricting chamber; the restricting chamber comprises a non-restricting portion and a restricting portion; at least a part of the extending arm of the first clutch is accommodated in the restricting chamber;
when the first pushing component is driven to move between the first end and the second end of the movable region, the extending arm of the first clutch is located in and restricted by the restricting portion from pivoting, whereby the toothed portion of the extending arm of the first clutch remains engaged with the splines of the transmission shaft;
when the first pushing component has been moved to the first end of the movable region and the transmission shaft keeps being driven to rotate in the first direction, the extending arm is moved to and pivots in the non-restricting portion, whereby the toothed portion of the extending arm of the first clutch is intermittently disengaged from the splines of the transmission shaft to prevent the transmission shaft from further driving the first pushing component.

6. The vertical blind of claim 5, wherein the headrail comprises an accommodating space and a base provided in the accommodating space; the restricting chamber is provided on the base for accommodating the extending arm of the first clutch.

7. The vertical blind of claim 5, wherein the headrail comprises a frame, an end cap, and an accommodating space; the end cap is provided at an end of the frame to define a boundary of the accommodating space; the restricting chamber is provided on an inner surface of the end cap for accommodating the extending arm of the first clutch.

8. The vertical blind of claim 3, wherein an imaginary line passing through the fixed end and the free end of the extending arm is substantially perpendicular to the axial direction of the shaft body of the transmission shaft.

9. The vertical blind of claim 3, wherein an imaginary line passing through the fixed end and the free end of the extending arm is substantially parallel to the axial direction of the shaft body of the transmission shaft.

10. The vertical blind of claim 1, wherein the transmission shaft comprises a sleeve and a shaft body; the sleeve fits around the shaft body and is non-rotatable relative to the shaft body;
when a first torque applied to the first clutch by the shaft body of through the sleeve is less than a predetermined torque value, the first clutch is engaged with and rotates along with the sleeve of the transmission shaft;
when a second torque applied to the first clutch by the shaft body of through the sleeve is greater than the predetermined torque value, the first clutch slips relative to the sleeve of the transmission shaft.

11. The vertical blind of claim 10, wherein, when the second torque applied to the first clutch by the shaft body through the sleeve is greater than the predetermined torque value, at least one of the sleeve and the first clutch deforms temporarily.

12. The vertical blind of claim 11, wherein the sleeve comprises an outer ridge structure; the first clutch further comprises an inner toothed structure for engaging with the outer ridge structure of the sleeve so as to be driven by the transmission shaft; when the second torque applied to the first clutch by the transmission shaft through the sleeve is greater than the predetermined torque value, at least one of the sleeve and the first clutch deforms temporarily so that the inner toothed structure of the first clutch and the outer ridge structure of the sleeve are disengaged.

13. The vertical blind of claim 1, further comprising a positioning mechanism concurrently movable along with the first pushing component, wherein the headrail comprises a stop portion; the positioning mechanism and the stop portion collectively restrict the first pushing component from moving out of the movable region.

14. The vertical blind of claim 1, wherein when the first pushing component has been moved to the second end of the movable region and the transmission shaft keeps being driven to rotate in the second direction, the first clutch prevents the transmission shaft from further driving the first pushing component, whereby the first pushing component stays at substantially the second end of the movable region.

15. The vertical blind of claim 1, further comprising an intermediate device connected to the light-blocking member and provided between the first pushing component and the light-blocking member; when the transmission shaft drives the slats to turn from the first closed position toward the open position, the transmission shaft drives the first pushing component to push the intermediate device for moving the light-blocking member toward the non-blocking position.

16. The vertical blind of claim 15, wherein the intermediate device comprises a moving block; the first pushing component is engaged with the moving block; when the transmission shaft drives the slats to turn from the first closed position toward the open position, the transmission shaft drives the first pushing component to push the moving block for moving the light-blocking member toward the non-blocking position.

17. The vertical blind of claim 15, wherein the intermediate device comprises a driving ring and a swing arm; the first pushing component is engaged with the driving ring; the swing arm is connected to the driving ring and pivotable relative to the driving ring; when the transmission shaft drives the slats to turn from the first closed position toward the open position, the transmission shaft drives the first pushing component to push the driving ring for pivoting the swing arm, whereby to move the light-blocking member toward the non-blocking position.

18. The vertical blind of claim 15, wherein, when the transmission shaft drives the slats to turn from the open position toward the first closed position, the light-blocking member is driven by gravity to move from the non-blocking position toward the blocking position and pushes the intermediate device downward.

19. The vertical blind of claim 1, wherein the light-blocking member is supported by the first pushing component and separated from the slats so that the light-blocking member does not contact the slats while the light-blocking member is being moved between the blocking position and the non-blocking position.

20. The vertical blind of claim 19, further comprising a second clutch and a second pushing component, wherein the second pushing component is engaged with the second clutch; the first pushing component and the second pushing component are respectively moved in different directions with respect to the transmission shaft.
